(19) United States
(12) Patent Application Publication
(10) Pub. No.: US 2012/0011044 A1
(43) Pub. Date: Jan. 12, 2012

(54) METHOD AND SYSTEM FOR ISSUING PRIMARY SECURITIES IN A TRADING MARKET

(75) Inventor: Michael Vasinkevich, New York, NY (US)

(73) Assignee: RODMAN & RENSHAW, LLC, New York, NY (US)

(21) Appl. No.: 13/166,338

(22) Filed: Jun. 22, 2011

Related U.S. Application Data
(63) Continuation-in-part of application No. 12/861,450, filed on Aug. 23, 2010.
Application No. 12/861,450 is a continuation-in-part of application No. 12/861,491, filed on Aug. 23, 2010.
Application No. 12/861,491 is a continuation-in-part of application No. 12/713,921, filed on Feb. 26, 2010.
(60) Provisional application No. 61/393,222, filed on Oct. 14, 2010.
(60) Provisional application No. 61/156,354, filed on Feb. 27, 2009.

(51) Int. Cl. G06Q 40/00

(52) U.S. Cl. 705/37

(57) ABSTRACT

Methods and corresponding systems and non-transitory computer readable media are provided that cause at least one interface screen to be displayed on at least one client device associated with a primary issuer. The interface screen or screen generally includes information regarding an offering of primary securities and at least one form element for the primary issuer to define terms of an offer to sell the primary securities. The primary issuer may therewith submit an offer to sell the primary securities and confirm that the primary issuer is legally authorized to issue the primary securities. Thereafter, the offer to sell the primary securities may be communicated to a trading market for execution.

### RELATED APPLICATION

The present application is a continuation-in-part of U.S. patent application Ser. No. 12/861,450, filed on Aug. 23, 2010; a continuation-in-part of U.S. patent application Ser. No. 12/861,491, filed on Aug. 23, 2010; a continuation-in-part of U.S. patent application Ser. No. 12/713,921, filed on Feb. 26, 2010, which claims priority to U.S. Prov. Pat. App. No. 61/156,354 filed Feb. 27, 2009; and claims priority to U.S. Prov. Pat. App. No. 61/393,222, filed on Oct. 14, 2010, each of which is incorporated herein by reference in its entirety.

### BACKGROUND

The present application relates to computer implemented methods and systems that provide a platform to assist companies in raising capital and for investors to identify relevant opportunities for investment.

The process by which companies raise capital is typically lengthy and costly. Corporations, for example, may raise capital with an initial public offering (IPO), or one or more primary offerings of securities. IPOs and primary offerings often involve one or more investment banks, underwriters or placement agents, law firms specializing in securities law, brokers, etc., which can add significantly to the overall cost and several weeks to the timeline of the offering. Accordingly, there is a need for computer implemented methods and systems to assist companies in raising capital that do not have some or all of the drawbacks noted herein.

### SUMMARY

In at least one aspect, methods are provided that include the step or steps of causing at least one interface screen to be displayed on at least one client device, the at least one interface screen comprising at least one item of information regarding an offering of primary securities and at least one form element for an issuer of the primary securities to define terms of an offer to sell the primary securities; receiving from the at least one client device the offer to sell the primary securities and a confirmation that the issuer of the primary securities is legally authorized to issue the primary securities; and communicating the offer to sell the primary securities to a trading market.

In at least one embodiment, the trading market comprises at least one of an exchange and an over the counter marketplace.

In at least one embodiment, the primary securities comprise new equity securities indistinguishable from corresponding secondary securities in the trading market.

In at least one embodiment, the primary securities comprise new debt securities indistinguishable from corresponding secondary securities in the trading market.

In at least one embodiment, the method includes communicating the offer to a trading desk associated with an intermediary and communicating the offer to the trading market via the intermediary.

In at least one embodiment, the legal authority to issue the primary security requires a regulatory registration, and wherein the at least one interface screen comprises at least one form element for the primary issuer to confirm that the issuer has filed the regulatory registration for the offering and that the regulatory registration is still in force.

In at least one embodiment, the regulatory registration comprises a shelf registration.

In at least one embodiment, the at least one interface screen further comprises a display of market data associated with the primary securities in the trading market.

In at least one embodiment, the at least one item of information regarding the offering comprises a size of the offering or a number of primary securities that the primary issuer is authorized legally to sell, and wherein the at least one interface screen comprises a display of the cash value of the offering.

In at least one embodiment, the at least one item of information regarding the offering comprises a remaining cash value of the offering taking into account a size of the offering or a number of primary securities that the primary issuer is authorized legally to sell, and any securities previously sold in the offering.

In at least one embodiment, the method includes calculating a number of primary securities available for sale in the offering based on the remaining cash value of the offering and a market price of the primary securities in the trading market.

In at least one embodiment, the at least one interface screen comprises at least one form element for the primary issuer to specify instructions for selling the primary securities on the trading market, the method comprising communicating the offer to sell the primary securities with the instructions specified by the issuer.

In at least one embodiment, the instructions comprise an indication that the offer is at least one of a passive, a midpoint, an aggressive, a volume weighted average price (VWAP), a participate, a day offer, and a good till cancelled offer.

In at least one embodiment, the instructions comprise an indication that the offer to sell the primary securities is a market order, and wherein the offer communicated to the trading market is a market order.

In at least one embodiment, the primary securities are offered without underwriting.

In at least one embodiment, the primary securities are offered using at least one of an underwriter and a placement agent.

In at least one embodiment, the method includes receiving a deposit of a number of unissued, authorized securities for the offering from the issuer, wherein the at least one item of information regarding the offering comprises the number of unissued, authorized securities deposited.

In at least one embodiment, the method includes determining a remaining number of securities available to be sold in the offering based on the number of securities deposited and any securities sold in the offering, wherein the at least one interface screen comprises a display of the remaining number of securities available to be sold in the offering.

In at least one aspect, methods are provided that include the step or steps of receiving and storing details of an issuer and a shelf registration of said issuer, said shelf registration authorizing said issuer to sell primary securities up to a specified dollar amount; receiving, pursuant to a distribution agreement, a first number of unissued, authorized shares of said primary securities whose total value does not exceed said specified dollar amount; receiving, via a user interface, an order from said issuer to sell a second number of shares of said primary securities, said second number not exceeding said first specified number; and transmitting said order to a securities marketplace.

In at least one aspect, methods are provided that include receiving and storing details of an issuer and a shelf registration of said issuer, said shelf registration authorizing said issuer to sell primary securities up to a specified number of securities; receiving, pursuant to a distribution agreement, a first number of unissued, authorized shares of said primary securities that does not exceed said specified number of securities; receiving, via a user interface, an order from said issuer to sell a second number of shares of said primary securities, said second number not exceeding said first number; and transmitting said order to a securities marketplace.

In at least one embodiment, the method includes receiving an indication that at least a portion of said order has been executed.

In at least one embodiment, the method includes transmitting data comprising said indication to said user interface for display to said issuer.

In at least one embodiment, said user interface displays to said issuer a total dollar amount of shares of said primary securities sold.

In at least one aspect, methods are provided that include the step or steps of displaying at least one interface screen on a client device, the at least one interface screen comprising at least one item of information regarding an offering of primary securities and at least one form element for an issuer of the primary securities to define terms of an offer to sell the primary securities in a trading market; communicating the offer to sell the primary securities from the client device to a computing device coupled to the client device over a network; and confirming that the issuer of the primary securities is legally authorized to issue the primary securities.

In at least one embodiment, the trading market comprises at least one of an exchange and an over the counter marketplace.

In at least one embodiment, the primary securities comprise new equity securities indistinguishable from corresponding secondary securities in the trading market.

In at least one embodiment, the legal authority to issue the primary security requires a regulatory registration, and wherein the at least one interface screen comprises at least one form element for the primary issuer to confirm that the issuer has filed the regulatory registration for the offering and that the regulatory registration is still in force.

In at least one embodiment, the regulatory registration comprises a shelf registration.

In at least one embodiment, the at least one interface screen further comprises a display of market data associated with the primary securities in the trading market.

In at least one embodiment, the at least one item of information regarding the offering comprises a size of the offering or a number of authorized primary securities that the primary issuer is authorized legally to sell, and wherein the at least one interface screen comprises a display of the cash value of the offering.

In at least one embodiment, the at least one item of information regarding the offering comprises a remaining cash value of the offering taking into account a size of the offering or a number of authorized primary securities that the primary issuer is authorized legally to sell, and any securities previously sold in the offering.

In at least one embodiment, the interface screen comprises a display of a number of primary securities available for sale in the offering calculated based on the remaining cash value of the offering and a market price of the primary securities in the trading market.

In at least one embodiment, the method includes depositing a number of unissued, authorized securities for the offering with a provider, wherein the at least one item of information regarding the offering comprises the number of unissued, authorized securities deposited.

In at least one embodiment, the at least one interface screen comprises a display of a remaining number of securities available to be sold in the offering, the remaining number of securities available to be sold in the offering determined based on the number of securities deposited and any securities previously sold in the offering.

Corresponding systems and non-transitory computer readable media are also provided.

Additional aspects will be apparent in view of the description that follows.

### BRIEF DESCRIPTION OF THE FIGURES

FIG. 1 is a block diagram of a networked computer system according to one embodiment of the systems disclosed herein.

FIG. 2a is a block diagram of a computing device according to one embodiment of the systems disclosed herein.

FIG. 2b is a diagram showing feedback mechanisms in a computer system according to one or more embodiments of the systems disclosed herein.

FIGS. 3-4 depict interface screens usable in a primary offering feature according to at least one embodiment disclosed herein.

FIG. 5 is a flow diagram of a method for providing a primary offering feature according to at least one embodiment of the features disclosed herein.

FIG. 6 is a flow diagram of a method for providing a registration identification feature according to at least one embodiment of the features disclosed herein.

FIG. 7 is a flow diagram of a method for providing a block identification feature according to at least one embodiment of the features disclosed herein.

FIG. 8 is a flow diagram of a method for providing a workflow collaboration feature according to at least one embodiment of the features disclosed herein.

FIG. 9 depicts a search results interface screen according to at least one embodiment disclosed herein.

FIGS. 10-12 depict interface screens for users to submit offers and counteroffers according to at least one embodiment disclosed herein.

FIG. 13 is a flow diagram of a method for providing a workflow collaboration feature according to at least one embodiment of the features disclosed herein.

FIG. 14 is a diagram showing a relationship of parties in a private placement using the workflow collaboration feature.

### DETAILED DESCRIPTION

The present application generally describes computer implemented methods and systems that provide a platform for assisting companies in raising capital and/or investors in identifying relevant investment opportunities. Although the methods and systems of the present application are discussed in relation to certain types of investing situations, such as primary, secondary, and follow-on offerings, block trading, private investments, etc., it will be understood by those skilled in the art that the features disclosed herein are applicable to other types of investing and with other types of parties, and are thus not limited thereto.

In one or more embodiments, the methods and systems provide one or more platforms with various features, such as a primary offering feature, a registration identification feature, a block identification feature, a comparable investment identifier feature, a conditional indication of interest feature, a workflow collaboration feature, and an investor relations feature, each of which is described in greater detail below. A combination of features provided may differ between users. For example, a primary issuer may be given access to one set of features that include a primary offering feature, whereas an investor may have access to all of the features except the primary offering feature. Features may include sub-features, which may similarly be provided differently between users. The features may be made available through an online and/or offline portal accessible by users via a client device or via stand-alone software as will also be described in greater detail below.

### Exemplary Computing Environment

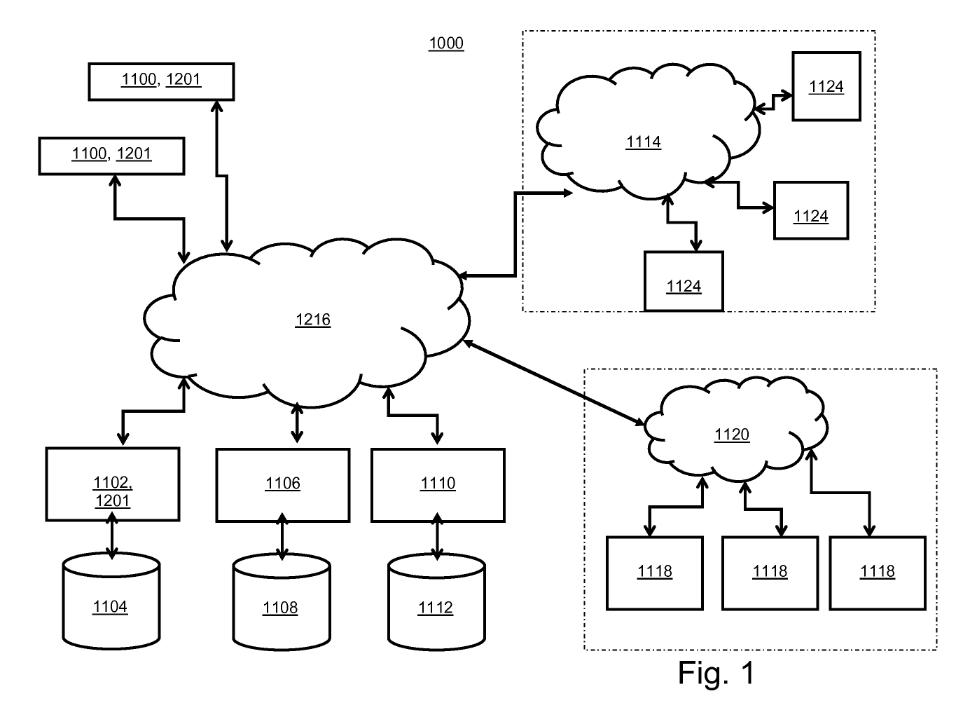

Referring to FIG. 1, a computer system for providing one or more features of the platform disclosed herein, according to at least one embodiment, is shown. The system 1000 generally includes at least one computing device 1201, such as a server computer 1102, 1106, 1110, a client computer 1100, 1118, 1122, or a combination thereof. In at least one embodiment, the system 1000 includes at least one server computer 1102 coupled over a communication network 1216 to one or more client computers 1100, 1118, 1122. The servers 1102, 1106, 1110 may be capable of accessing one or more databases 1104, 1108, 1112. The system 1000 may be implemented over any type of communications network, such as a local area network (LAN), a wide area network (WAN), the Internet, a telephone network (POTS), a wireless network, including cellular and Wi-Fi networks, or combinations of wired and/or wireless networks. For example, the client devices 1118 may access the functionality provided by the servers 1102 directly over a LAN/WAN 1120. Alternatively or additionally, clients 1116 may access the functionality provided by the servers 1102 indirectly over a LAN/WAN 1114. The client computers 1100, 1118, 1122 are preferably configured or otherwise capable of transmitting and/or receiving communications to and/or from the one or more server computers 1102, 1106, 1110, including any items of data discussed herein. This may be accomplished with a communication interface that enables communication with a similarly equipped server computer, wirelessly, wired, or a combination thereof. In at least one embodiment, the client computers 1100, 1118, 1122 generally provide the front-end functionality and one or more server computers 1102, 1106, 1110 provide the back-end functionality discussed herein.

The client computers 1100, 1118, 1122 may be any device operable to provide the functionality disclosed herein, including communicating with the one or more servers and/or other client devices, displaying information with one or more interface screens, collecting information from users thereof, retrieving data, storing data, etc. For example, the client computers may be a mobile phone, a smart phone or tablet, a personal computer (PC), as well as any dedicated or general purpose computer terminal The front-end functionality may be provided with a browser or any other generic application, or with special purpose software or “apps” designed specifically for accessing and providing the features disclosed herein.

The platform features disclosed herein may be used by various parties. For example, a platform may provide features to assist companies in raising capital and for investors to identify relevant investment opportunities. In this instance, the client computers 1100 may be operated by companies or any business entity wanting to raise capital, such as corporations, public and private companies, limited liability companies, partnerships, etc., whereas client computers 1100, 1118, may be operated by investors looking for investment opportunities, such as institutional investors, etc. Additionally, the processes performed with a platform may involve one or more intermediaries, such as a broker, an investment bank, mediator, etc., which may access the features of the platform with client computer 1118.

The platform features are generally operated or otherwise made available by one or more providers via the one or more server computers 1102. Some of the features of the platform may be provided in conjunction with a third party or parties. For example, a provider may obtain information in connection with the one or more features through third party data providers, such as from a regulatory database (e.g., as the SEC's EDGAR), a commercial data provider (e.g., Bloomberg, Reuters, etc.), or any other public or private data source. The provider server or servers 1102 may be coupled to one or more third party servers 1106 and/or databases 1108.

The provider or a third party may also allow companies, investors, intermediaries, or other users of the system 1000 to trade via one or more electronic trading platforms, marketplaces, and/or exchanges, such as via an electronic communication network (ECN), etc. In this instance, the users of the system 1000 may further have access to one or more exchange or marketplace servers 1110. That is, the client devices 1100, 1118, 1112 may communicate trade orders directly to the exchange server 1110 or indirectly to server 1110 via provider server 1102.

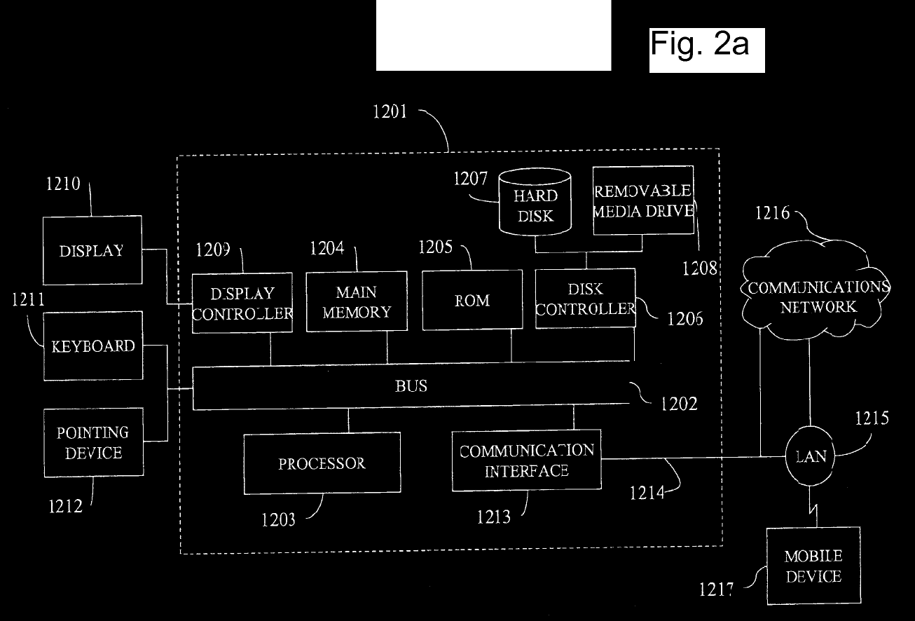

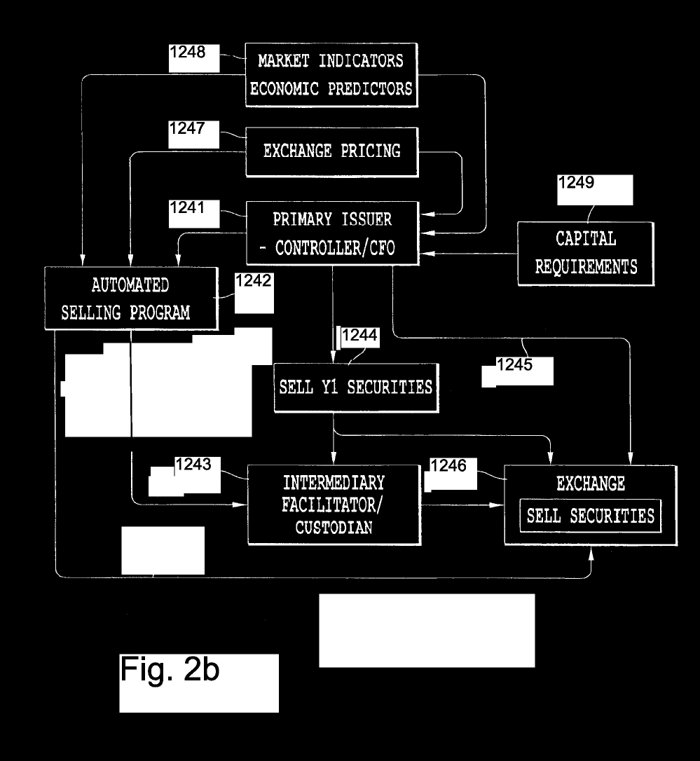

Referring to FIG. 2a, an exemplary computing device 1102 according to at least one embodiment is shown. In one embodiment, the computing device 1201 includes a bus 1202 or other communication mechanism for communicating information between components of the device 1102, and a processor 1203 coupled with the bus 1202 for processing the information. The device 1201 may also include a main memory 1204, such as a random access memory (RAM) or other dynamic storage device (e.g., dynamic RAM (DRAM), static RAM (SRAM), and synchronous DRAM (SDRAM)), coupled to the bus 1202 for storing information and instructions to be executed by processor 1203. In addition, the main memory 1204 may be used for storing temporary variables or other intermediate information during the execution of instructions by the processor 1203. The device 1201 may further include read only memory (ROM) 1205 or other static storage device (e.g., programmable ROM (PROM), erasable PROM (EPROM), and electrically erasable PROM (EEPROM)) coupled to the bus 1202 for storing static information and instructions for the processor 1203. The at least one computer readable medium or memory may have stored thereon programmed instructions and/or contain data structures, tables, records, or other data described herein.

The device 1201 may also include a disk controller 1206 coupled to the bus 1202 to control one or more storage devices for storing information and instructions, such as a hard disk 1207, and a removable media drive 1208 (e.g., floppy disk drive, read-only compact disc drive, read/write compact disc drive, compact disc jukebox, tape drive, and removable magneto-optical drive). The storage devices may be added to the device 1201 using an appropriate device interface (e.g., small computer system interface (SCSI), integrated device electronics (IDE), enhanced-IDE (E-IDE), direct memory access (DMA), or ultra-DMA).

The device 1201 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computing device 1201 may also include a display controller 1209 coupled to the bus 1202 to control a display 1210, such as a cathode ray tube (CRT) or liquid crystal display (LCD), for displaying information via the one or more interface screens disclosed herein to a user thereof. In one exemplary embodiment, the device 1201 includes at least one input device, such as a keyboard 1211 and a pointing device 1212, for a computer user to interact with the device 1201 and to provide information/instructions to the processor 1203. The pointing device 1212, for example, may be a mouse, a trackball, a pointing stick, a track pad, a touch screen, etc. In addition, a printer may provide printed listings of data stored and/or generated by the computer system 1201.

The computing device 1201 generally performs a portion or all of the processing steps disclosed herein in response to the processor 1203 executing one or more sequences of one or more instructions contained in a memory, such as the main memory 1204. Such instructions may be read into the main memory 1204 from another computer readable medium, such as a hard disk 1207 or a removable media drive 1208. The instructions stored may be in any form, including without limitation executable code, scripts, interpretable programs, dynamic link libraries (DLLs), Java classes, application program interfaces (APIs), complete executable programs, or a combination thereof

The computing device 1201 may also include a communication interface 1213 coupled to the bus 1202. The communication interface 1213 provides a two-way data communication coupling to a network link 1214 that is connected to, for example, a local area network (LAN) 1215, or to another communications network 1216, such as the Internet. For example, the communication interface 1213 may be a network interface card to attach to any packet switched LAN. As another example, the communication interface 1213 may be an asymmetrical digital subscriber line (ADSL) card, an integrated services digital network (ISDN) card, or a modem to provide a data communication connection to a corresponding type of communications line. Wireless links may also be implemented. In any such implementation, the communication interface 1213 sends and receives electrical, electromagnetic, or optical signals that carry digital data streams representing various types of information.

The network link 1214 typically provides data communication through one or more networks to other data devices. For example, the network link 1214 may provide a connection to another computer through a local network 1215 (e.g., a LAN) or through equipment operated by a service provider, which provides communication services through a communications network 1216. The local network 1214 and the communications network 1216 use, for example, electrical, electromagnetic, or optical signals that carry digital data streams, and the associated physical layer (e.g., CAT 5 cable, coaxial cable, optical fiber, etc). Moreover, the network link 1214 may provide a connection through a LAN 1215 to a mobile device 1217, such as a personal digital assistant (PDA) laptop computer, or cellular telephone or any other type of client device.

Referring to FIG. 2b, a diagram is provided that depicts exemplary feedback mechanisms and influencing data feeds for selling new securities in a secondary or trading market as discussed below. Instructions for selling and issuing new securities may be originated at the primary issuer, for example, by a Chief Financial Officer acting on behalf of the primary issuer or any authorized person 1241 via a client device. A primary issuer as used herein refers to a company or business entity, such as a corporation, which authorizes and/or approves the issuance and first sale of its security, for example, according to the rules of its charter or otherwise. The primary issuer may delegate selling responsibilities to an automated selling program 1242 executed by one or more servers such that sales of the new securities by means of the shelf offering are carried out automatically without further human assistance. The automated sale program may key or index sales volumes, prices, and the like of the offer to sell new securities on the trading market to financial indicators, such as opening highs/lows, price spreads, volume and the like. The automated selling program 1242 may then directly, in an automated manner, provide instructions to sell certain amounts of the new securities at certain prices directly to an exchange supporting the trading market for the securities. Alternatively or additionally, the program may provide such instructions to an intermediary, facilitator or custodian, such as a broker or market maker 1243, which then places orders directly on the exchange 1246 or purchases such new securities for its own purposes.

In another embodiment, the primary issuer 1241 provides instructions for issuing and/or selling new securities directly to the intermediary without the intervention of an automated selling program. The issuer 1241 may give such instructions in a message 1244 in a generic manner identifying only the number of shares or may give more specific instructions by which the new securities are sold under only particular market conditions. Alternately, the primary issuer 1241 may place a sale order through a broker without the intervention of any underwriter 1245. The exchange 1246, which provides a trading market for the primary issuer's securities, concurrently processes buy and sell orders for securities that are not new that may be the same as or indistinguishable from the primary securities offered for sale by the primary issuer as part of the shelf or other type of primary offering. In this way, the primary issuer minimizes the impact on the market price of the security being sold.

FIG. 2b also shows influencing factors that may act on the primary issuer. The primary issuer may be cognizant or reactant to external economic indicators, such as market indices 1248. The primary issuer may likewise be influenced by or monitor the pricing of the securities of its competitors, which may occur on the same exchange or on different exchanges. The primary issuer likewise may monitor exchange pricing 1247 for corresponding securities traded on the exchange 1246. The primary issuer may also be influenced by or take into account internal data in providing instructions for selling the new securities 1249. Internal indicators may include, for example, the capital needs of the primary issuer.

The processes discussed herein may involve a broker, facilitator, mediator and/or agent in the sale of a primary offering of a new security. The issuer may interact directly with the exchange, without any services of the broker, mediator, facilitator or agent. In other embodiments the primary issuer acts first through a mediator and not directly with the exchange. The mediator may offer a series of services for the benefit of the primary issuers. For example, the mediator may interact with the buyer to arrange for and settle the transfer of shares from the primary issuer to the buyer and/or to accept cash from the buyer in exchange for the new securities sold by the primary issuer.

In at least one aspect, the system 1000 includes means and devices for providing computer-implemented trading for primary securities, including providing respective computer-generated interfaces for a plurality of primary issuers, security holders, dealers, and investors to interact with the system. The interfaces may enable electronic messaging between the parties and/or parties, whether buy or sell side, to submit orders in or through the system 1000 for execution, etc. Buy and sell offer messages between buyers, sellers, and intermediaries may be accepted or rejected using an appropriate interface as will be described in greater detail below. Messages as well as stock market alerts, order status messages, client inquiries, market data, etc., may be communicated to the respective user in real time or otherwise. Messaging between users and the system may be communicated using any type of communication protocol, including, without limitation, a Financial Information eXchange (“FIX”) protocol.

### Exemplary System Registration

As noted herein, in one or more exemplary embodiments the platform provides a portal for various users to access one or more of the features discussed herein. In at least one embodiment, accessibility to one or more of the features is limited to certain individual users or types of users. A registration procedure may be used to set up user access to the one or more features or sub-features. The registration procedure generally involves obtaining and/or verifying user data, such as a user name, address, company being represented, the role or title of the user in relation to the company, regulatory registrations/status of the user, email address, phone number or numbers, unique ID, password, biometric information, etc. For example, a user John Doe, Chief Executive Officer (CEO) of Company ABC, may register for one or more of the features by entering data online via an account set up interface screen displayed on a client device 1100. Alternatively, a person associated with the provider may obtain this information, and enter the information into a closed registration system with an indication of which features a particular user will be able to access. For example, referring to Table A, the person entering the information into the system may indicate whether a given user may be able to access the primary offering feature (F1), the registration identification feature (F2), the block identification feature (F3), the workflow collaboration feature (F4), the comparable investment identifier feature (F5), the conditional indication of interest feature (F6), and the investor relations feature (F7), etc. Alternatively or additionally, access to the feature or features may be controlled by an indication with regard to the type of user being registered, e.g., primary issuer, investor, etc. If an agent associated with the provider of one or more of the features disclosed herein is assigned to a particular company, the company may be tied to one or more agents via an agent/company data table. The user's data may be communicated to and correspondingly received by the server 1102, which stores user data in a data structure or table associated with database 1104. The user data is preferably confirmed in an online and/or offline process. Table A below shows a sample data table storing user data.

TABLE A

| | | | | | Com- | | |
|---|---|---|---|---|---|---|---|
| | | | Pass- | | pa- | | |
| Name1 | Name2 | ID | word | Email | ny ID | F1 | F2 |
| John | Doe | JD1 | Passw1 | JD1@ABCco.com | ABC, | T | F |
| | | | | | Inc. | | |
| Jane | Doe | JD2 | Passw2 | JD2@ABCco.com | ABC, | T | T |
| | | | | | Inc. | | |
| Joe | Smith | JS1 | Passw3 | JS1@ABCco.com | ABC, | F | F |
| | | | | | Inc. | | |

The system 1000 may thereafter use the stored user data in an authentication procedure to provide access to one or more features of the platform. The features may be limited by any one of the items of user information. For example, certain features may be limited to certain types of companies, e.g., public vs. private. Similarly, features may be limited alternatively or additionally based on the role of the user in relation to the company and/or in a transaction. For example, executives, such as the CEO and the CFO of a company, may have different access as compared to a marketing specialist or compliance officer for the company, and company insiders may have different access than investors, brokers, private placement agents, or any other intermediary. Similarly, primary issuers may have different access as compared to investors. Additionally or alternatively, access to particular features may be restricted with data in the user data table indicating which features the user can access. For example, a user may be able to access the primary offering feature (F1) with an indication in the user data table, such as a Boolean data type (true/false), indicating that a given user has access to the primary offering feature. Access to the other features may similarly be limited.

Accessibility of one or more of the features disclosed herein may also be limited with respect to the type of company or the role of the company in the transactions discussed herein that a given user is associated with. In this respect, the platform may maintain a registry that includes company specific information. For example, a company registry or registries may be maintained that includes company information, such as company name, ID, address, main contact information, type of company, (e.g., corporation, private/public, brokerage, investor, investment bank, etc.), regulatory registrations/status of the company (e.g., effective shelf registration, expiration of the shelf registration, shelf registration identification number, limitations thereto, etc.), financial data (e.g., maximum number of shares or maximum size of one or more primary offerings, shares approved and/or deposited for the one or more offerings, market capitalization, shares outstanding, geographic region, sector, market price, trading volume, or any statistical derivations thereof, etc.), one or more company executives, agents for order placement, transaction data (e.g., details regarding securities sold, purchased, pending, etc.), conditions or limitations with regard to specific features and/or specific users, etc. Table B provides a sample set of company data. A similar registry may be maintained for investors.

Company information may be obtained via a registration procedure such as that described above or with a separate registration procedure for the company. The company information may be communicated to and correspondingly received by the server 1102, which stores company data in a data structure or table associated with database 1104. Some or all of the company data may also be obtained via a third party data provider, which may be the source of the data, or an intermediary that receives the data from the source. For example, registration status may be obtained directly from the EDGAR or any SEC (Securities and Exchange Commission) database. Other company data may be obtained from third party data providers, such as Bloomberg, etc. The data may be pushed to the provider and/or may be obtained from existing data, such as the EDGAR database, web pages, email or other messages, etc. The system 1000 may thereafter use the company data to provide access to the one or more features of a platform.

TABLE B

| Compa- | | Main | | Regis. | Sym- | Open |
|---|---|---|---|---|---|---|
| ny ID | Type | Contact | Regis. | Exp. | bol | Share |
| ABC, | Public | John | Shelf | Jan. 1, 2013 | ABC | 1500000 |
| Inc. | | Doe | | | | |
| DEF, | Public | James | Shelf | Jan. 1, 2012 | DEF | 2000000 |
| Inc. | | Smith | | | | |
| GHI, | Private | Jane | — | | | |
| Inc. | | Smith | | | | |

As will be explained in greater detail below, this as well as other data may be used to match or pair primary issuers or, in general, companies with those parties having interest or that may potentially be interested in particular investment opportunities relating to primary issues or, in general, to securities held by a particular company or investor. Similar data structures may be maintained for companies, block holders, block purchasers, investors, or any other user of the system for subsequent matching or otherwise.

As noted above, an exemplary platform provides one or more features, such as one or more of: a primary offering feature, a registration identification feature, a block identification feature, a comparable investment identifier feature, a conditional indication of interest feature, a workflow collaboration feature, and an investor relations feature. The features themselves may provide one or more sub-features, and features and sub-features may be invoked from another feature or sub-feature. For example, a user and/or the system 1000 may invoke and tie the user's actions in the registration identification and block identification features with the workflow collaboration features. Similarly, a user and/or the system may invoke and tie the user's action in the primary offering features with the investor relations feature or sub-features. In authenticating the user, the system 1000 receives user data, such as ID and password, e.g., via a log-on interface screen displayed on a client device 1100, and determines therefrom, based on one of the other items of user data and/or company data, whether or not to provide the user with access to the one or more features of a platform. The features are generally accessible via an interface screen presented after authentication, such as a home page, which allows users to select one or more of the features and interact with the platform accordingly. In addition to accessing features on a dedicated terminal or a web-based interface, users may also access features through their own order management system (OMS) and/or execution management system (EMS). That is, one or more of the features discussed herein may be accessed or accessible as an add-on that integrates one or more of the features into an existing order and/or execution management system. Although the features are discussed herein separately, the existence of the features separately may not necessarily be apparent to the users. For example, investors may access registration and block identification features through a common portal or interface. Similarly, a comparable investment identifier feature, a conditional indication of interest feature, and an investor relations feature may be accessed through a common portal or interface. In one embodiment, once authenticated, a primary issuer may be provided with an interface screen or screens that allow the primary issuer to access or be provided information from the primary offering feature, the investor relations feature, and the workflow collaboration feature. Similarly, an investor, once authenticated, may be provided with an interface screen or screens that allow the investor to access or be provided information from the registration identification feature, the block identification feature, the workflow collaboration feature, the comparable investment identifier feature, the conditional indication of interest feature, and/or the investor relations feature, or any combination thereof

As discussed below with regard to a comparable investment identification feature, an exemplary system may identify and suggest to particular users parties that may be of interest to the users for a trade of one or more securities based on information that infers a sentiment of the particular user with regard to one or more securities. Sentiment may be inferred from various types of data. For example, sentiment may be inferred from a user's trading history, including from actual trades as well as from interactions with the system 1000 that do not result in trades, such as bids, asks, hits, takes, requests for quotes (RFQs), indications of interest, invitations to negotiate, cancellations, types of orders, timing of orders, instructions regarding expiration of orders, etc., with regard to a particular security, company, sector, etc. The information for sentiment may be derived from pending orders as well as orders that have been executed and/or cancelled.

Sentiment may also be inferred from more general interactions that a user performs with the system 1000 or with a third party. For example, a user may request the market price or news for one or more companies without actually submitting a trade for any of the companies or for fewer than all of the companies. In these instances, the system 1000 may infer a user's sentiment with regard to a company or sector from trading and non-trading data, or a combination thereof, and recommend to the user potential parties for a trade. In addition to inferred sentiment, the system 1000 may take into account the users' express sentiment. That is, users may specify specific companies, types of companies, sectors, etc. that the user may be interested in or not interested in. This information may be stored, for example, in a user profile.

The information used to infer sentiment may be derived from various sources. For example, the system 1000 may maintain a log or logs regarding the user's interaction with the system 1000. The system 1000 may also acquire information from third party systems, such as from one or more exchanges, markets, proprietary systems that represent dark pools of liquidity, etc. For example, the system 1000 may obtain trade information regarding pending orders or quotes from a trading or quotation platform(s) or market(s), such as an interdealer electronic quotation system, or generally any trading or quotation platform, including without limitation execution or order management systems, order entry systems, order books (e.g., blotters), etc. That is, the system 1000 may obtain, from the trading or quotation platform or market, trade information, including price and size information from pending, executed, and/or cancelled orders for specific listed or unlisted securities. In at least one embodiment, the system 1000 obtains trade information regarding pending orders, including without limitation the information noted above, and uses the information obtained, for example, to infer investor sentiment or otherwise match investor interests with potential sellers, or the reverse. Either of the buy side or sell side information may be obtained depending on whether the securities or parties for a trade are being identified for a potential buyer or a potential seller. As will be discussed below, the information obtained from a trading or quotation platform or market may be used to identify parties in connection with the registration identification feature, the block identification feature, the comparable investment identifier feature, the conditional indication of interest feature, and the workflow collaboration feature, as well as the buy back aspect of the primary offering feature.

Sentiment with regard to a company or any other variable may be assigned a numerical score that the system 1000 may use to identify the most relevant potential counter parties for a trade. The sentiment score may be performed periodically or continuously, in real time or otherwise, so that any sentiment inferred may timely reflect the user's sentiment under the then current market conditions. Some types of information may be more probative of sentiment than other types of information. For example, express sentiment may have greater weight than requests for information that do not result in a trade. In generating a sentiment score, the system 1000 may therefore apply one or more weights to the different types of information considered.

### Primary Offering Feature

Companies raise capital for general investment and operating purposes, for example, by selling securities such as common stock, preferred stock, debt, convertible debt, non-convertible debt, warrants, options or other derivatives, etc., or a combination thereof. When in the form of shares of equity (stock) and/or when equity linked, these types of securities entitle the holders to a fractional ownership interest in the entity that issued the securities.

The first sale of a company's securities is known as a primary issue (i.e., a sale of the company's securities by the company itself). A primary issue may be in the form of an initial public offering (IPO), which is the initial public sale of shares of equity in the company. Primary issues also include the sale of any new securities issued subsequent to an IPO. Subsequent issues are still considered primary issues because the securities are being offered for sale by the issuer. Subsequent issues include primary and secondary offerings. Any sale of particular securities after their primary issue is considered a secondary sale in the trading market, e.g., in an exchange with which the securities are listed or unlisted. For the purpose of this application, a primary offering is an issuance of new securities other than an IPO. Secondary offerings, as such term is used in this application, in contrast, include securities that are not new. In certain instances, regulatory registration, approval, and/or communications may be necessary before, concurrently, or after the primary offering as will be explained below in greater detail in relation to the features of the platform.

Under certain circumstances the sale of newly issued securities subsequent to an IPO (e.g., primary offerings) may be subject to less stringent regulatory and reporting requirements. Nonetheless, in most cases an underwriter or placement agent may still be involved in primary offerings. While the underwriter's or placement agent's fee and/or commission may be lower for subsequent primary issues than for IPOs, fees typically ranging from 5 to 7% and up to 10% of the proceeds raised are common.

The primary issuer/company carrying out a primary issue is typically subject to one or several disadvantages. First, the issuer is burdened with the underwriter's/placement agent's fee and is thus unable to efficiently and fully capitalize on its goodwill and reputation. Second, the timing and frequency of the primary sales may be dictated by the underwriter, thereby prohibiting the company from taking full advantage of market conditions when planning and/or executing sales. The price of the shares sold on the trading market may also erode as speculators enter the market anticipating a change in the volume of sales. Third, the issuer's management team may be distracted from carrying out the function of running the company. Fourth, the costs for marketing reduce the issuer's proceeds from the offering. Costs can include expenses associated with road shows, printing a prospectus and other costs associated with conforming to applicable regulatory guidelines.

An exemplary primary offering feature provides a method or methods for issuing and/or selling primary issues of securities, in some embodiments other than IPOs, directly into a trading market, with or without the services of an underwriter. An exemplary primary offering feature allows users thereof to engage in primary offerings without subjecting the issuer to one or more of the disadvantages noted above. A primary offering feature according to an exemplary embodiment, provides a process that allows U.S. listed/unlisted public companies to sell primary shares directly into a trading market in such a manner that allows the issuer to be in control of when and at what price the shares are sold. The system 1000, with this feature, therefore generally permits the primary issuer to define conditions of the primary sale, such as the number (e.g., by value and/or volume) of new securities to be sold on the trading market, the date and/or time the securities are to be sold, the price at which the securities are to be sold, etc., or a combination thereof. Once defined, the system 1000 provides a platform for the issuer to carry out the sale of primary issuances on the trading market directly, with or without the services of an underwriter, thereby eliminating or otherwise ameliorating one or more of the other disadvantages associated with primary offerings.

As noted herein, regulatory registration, approval, and/or communications may be necessary before, concurrently, or after a primary offering. For example, a shelf or other regulatory registration may be required before or concurrently with a primary offering. In this instance, the system 1000 may require evidence or a confirmation from the user of the system that the issuer selling the primary issues using a primary offering feature has filed any necessary registration and/or received any necessary approval for the primary offering, such as confirmation that the issuer filed one or more registration statements or forms with the SEC, including without limitation forms S-1, S-2, S-3, S-4, S-8, S-11, S-20, SB-1, SB-2, S-3, S-3ASR, S-4, B-2, F-1, F-2, F-3, F-6, F-7, F-8, F-9, F-10, F-80, etc, or any other current or future form. Although the regulatory authority to sell primary issues is discussed herein by way of example with reference to registering the primary offering with the SEC, it is understood that the regulatory authority to sell primary issues includes other types of regulatory authority to sell, including authority under state saw and laws of foreign jurisdictions. Further evidence or confirmation may be required at various times throughout the process.

An effective shelf status is a regulatory characterization indicating that the primary offering has received regulatory approval allowing the issuer to issue a predetermined size in terms of the total dollar amount or number of securities, and a type of securities. Various types of shelf registrations may be filed. For example, certain primary issuers may file automatic shelf offerings (ASR), continuous shelf offerings, delayed shelf offerings, etc. In these instances, primary issuers pre-register the new securities without a specific issue date. The actual issue date may be delayed for a period of several years, which allows securities to be issued quickly, without delay of further regulatory review.

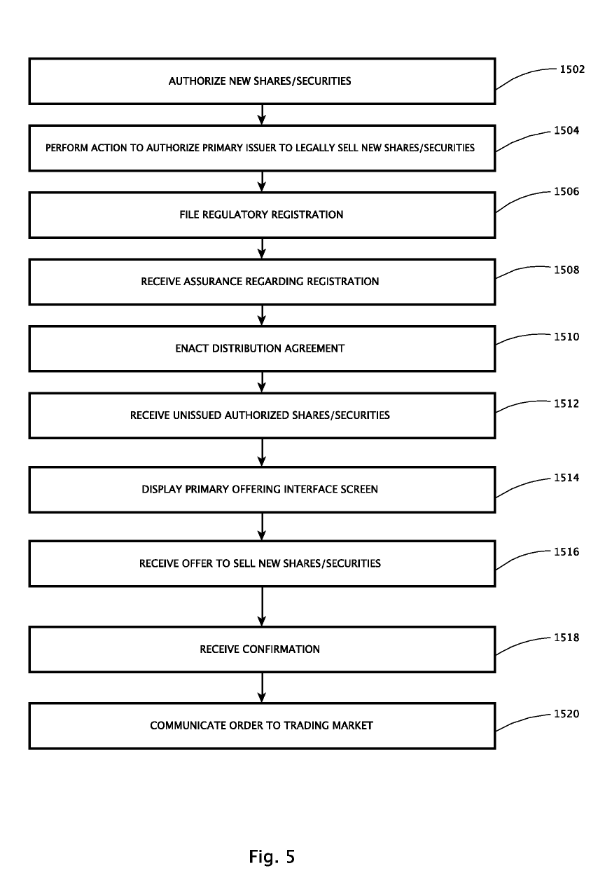

Referring to FIG. 5, an exemplary method for providing an exemplary primary offering feature begins at 1502, preferably after registration and/or authentication with the system 1000, with the primary issuer authorizing the issuance of new securities in terms of a maximum size or number of shares. That is, new securities, such as stock in a corporation, may be issued under the direction of a Board of Directors. The shareholders and/or owners of the corporation typically place limits on the number of or types of securities that may be issued by the Board of Directors. For example, a shareholder vote may be required for Board of Directors to issue 20% or more of a company's outstanding stock. Shareholders therefore may authorize the Board of Directors to issue securities with certain specified limits.

Once the new securities are authorized, the primary issuer may take the necessary action to authorize it to legally sell the new securities at 1504. The steps necessary to authorize the primary issuer to legally sell new securities may vary. In at least one embodiment, the primary issuer does so by filing a shelf registration or any other regulatory registration at 1506. The provider may receive evidence and/or assurance from the issuer regarding the regulatory registration at 1508 with any details regarding the regulatory registration. Alternatively or additionally, the legal authority to sell issues may be contractual or based on internal company policy rather than regulatory. In this instance, the issuer enters into and satisfies terms of one or more agreements or policies that authorize it to sell new securities. For example, if a distribution agreement is desired or required, the provider and/or the primary issuer may execute a distribution agreement at 1510.

In one embodiment, a distribution agreement may require that the primary issuer deposit a sufficient number of unissued, authorized securities with the provider or with another entity before being able to submit offers to sell the new securities using a primary offering feature. By requiring primary issuers to deposit securities in advance, prospective buyers will have assurance that the securities being purchased exist and will be delivered. In these instances, the provider may receive from the issuer a deposit of a number of unissued, authorized securities at 1512. The primary issuer may deposit fewer than all of the securities authorized. In these instances, the system may limit sales to the number of securities deposited with the provider. Alternatively, securities may be delivered at some time after sales are posted.

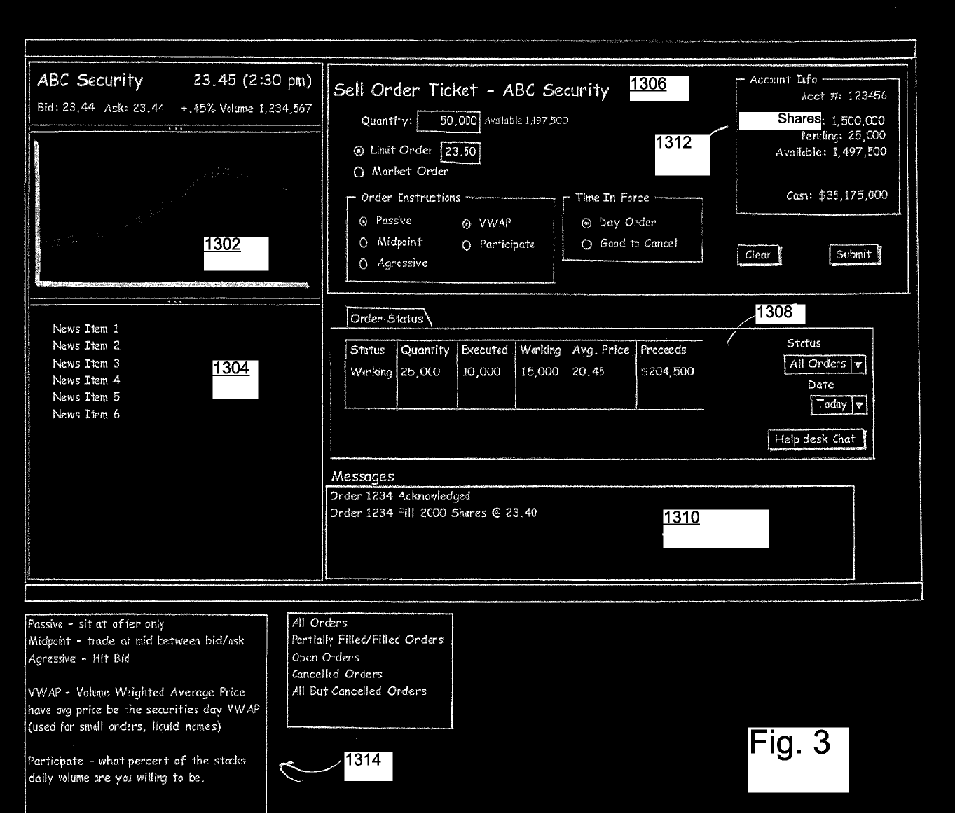

Once approved, the primary issuer may thereafter use a primary offering feature disclosed herein to sell new securities directly into the trading market. To facilitate this, details regarding the company noted above and/or the primary offering are stored on the system 1000. For example, if the primary offering has any limitations, such as an expiration date or limit with regard to the size of the offering or number of shares sold, this information may be stored for the system 1000 to enforce any necessary limitations. Similarly, the number of new securities deposited may be entered into the system 1000. Thereafter, the primary issuer or an agent thereof may invoke the primary offering feature, for example, by selecting a corresponding link on an interface screen/webpage provided by the system 1000 to the user. In response, the system 1000 may cause a primary offering interface screen, such as the interface screen shown in FIG. 3, to be displayed to the user via a client device at 1514. The interface screen may include various types of information relevant to the primary issuer. For example, market data regarding the company and/or the primary security in the trading market, real time or otherwise, may be provided in a market data window 1302, news regarding the company may be shown in a news window 1304, etc. Non-company specific data may also be provided, such as a real time ticker, related news stories, advertisements, etc.

In at least one exemplary embodiment, an interface screen includes an order window 1306 that includes therein a plurality of form elements, such as text boxes, drop down menus, radio buttons, etc., for the company to enter data and to generate therewith a sell order ticket. The order window may include form elements that allow the primary issuer to enter variables, such as quantity, price, and instructions, such as whether the order will be passive, midpoint, aggressive, volume weighted average price (VWAP), participate, day order, good until cancelled, etc., or a combination thereof. Buttons may be provided for the user to submit or clear the order. The interface may also include a primary offering information window 1312 with information regarding the primary offering. For example, window 1312 may include the size or cash value of the offering and may include the corresponding number of shares approved, legally authorized, and/or deposited with the provider for the primary offering, pending shares, and total shares available for sale in the primary offering taking into account any shares that have been sold previously or that are committed in a pending sale. This window may also provide an indication of the cash value of the primary offering or a portion thereof and may determine the number of shares available for sale based on the market price of the shares being offered and the approved and/or legally authorized size of the offering. The system may account for sales of new securities sold through the system and may account for any sales outside of the system. The system may also determine the remaining cash value of the offering taking into account any shares sold. Certain companies, such as well known seasoned issuers (WKSI), may be able to file an automatic shelf registration that does not require the filer to specify a dollar amount of securities for the primary offering at the time of filing. In these instances, the interface screen may show that the primary offering from which new securities are being sold is covered under an automatic shelf registration rather than the cash value of the offering or a portion thereof. This or another interface screen may also show the status of any prior orders, pending or otherwise, in an order status window 1308, system messages in window 1310, a help section 1314, advertisements, etc.

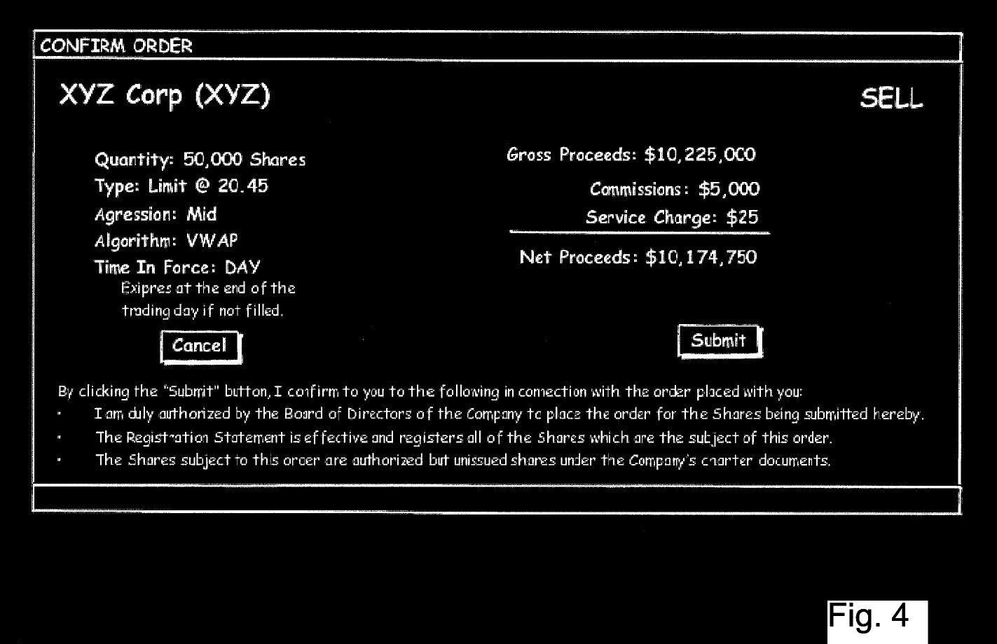

Once an order is submitted by the issuer and received by the system at 1516, the system 1000 may confirm the details of the order, e.g., whether certain limits on the number of shares being offered are satisfied. A confirmation screen, such as the screen shown in FIG. 4, may be displayed for the primary issuer to confirm the order. The confirmation screen may further require that the primary issuer confirm or re-confirm that any approval, legal authorization, and/or regulatory registration necessary has been obtained and is still in force. Once confirmation is received at 1516, the order ticket may be received by the system 1000 and the order may then be communicated to an exchange or marketplace for sale in the trading market at 1520. The order ticket may be routed indirectly, for example, through a broker-dealer agent.

The trading market provides a fluid system of offers to buy and offers to sell the primary issue. The trading market typically includes one or more national exchanges, off-exchange OTC markets, etc. The trading market also may include pools or pockets of liquidity, also known as dark pools. In this respect, the system 1000 may format the order of the new securities into a format compatible with that of a particular market prior to sending the order for execution to that market. The order itself may be sent to multiple markets. In this instance, the system 1000 formats the order into a plurality of different formats prior to sending the orders to disparate markets. In this respect, the system 1000 may selectively send primary issue orders to be sold openly on an exchange and/or marketplace through any channel or sales path.

In at least one embodiment, the system 1000 sends the order to sell primary securities to a trading desk associated with the provider of the system 1000. In this instance, a person operating the trading desk may confirm the order from the primary issuer and forward the order, for example, to an order management system (OMS)/ execution management system (EMS) for execution. The system 1000 may include an indication with the order that the order is that for a primary security. In this instance, the trading systems that receive the order may identify electronic coding or labeling which distinguishes the primary issuer's offer to sell primary securities from offers from other sellers to sell secondary securities. This information may be shown in a display or blotter that shows the depth in the market for a particular security. Alternatively, this information may not be displayed in order to provide a certain level of anonymity with regard to the primary offering. This information may be used, however, to distinguish the trade of new securities over trade of securities that are not new, for example, to generate a link that is sent to the buyer of the primary shares that is selectable for the buyer to access a prospectus of the primary offering.

In certain instances, the primary issuer may arrange for the sale of the primary security through one or more intermediaries or brokers. The intermediary may be a clearinghouse, a market maker, and/or Financial Industry Regulatory Authority (FINRA) member. In this instance, the primary issuer may arrange for the sale of the primary security through the broker or intermediary contractually such that the primary issuer represents and guarantees delivery of the primary securities to the party carrying out sales on the exchange and/or marketplace on the primary issuer's behalf

Once the primary securities are traded in the trading market, the details of the trade may be communicated to the system 1000 and the issuer's account may be updated to reflect the trade of primary shares. For example, if all or a portion of the order has been accepted, the system 1000 may determine the number of securities or the cash value thereof available to be sold in the primary offering by subtracting the amount of securities sold from the number of previously available securities. The details of the trade may be displayed to the user in an interface screen, including details, such as, the number of securities sold, the average sale price per security, the number of securities available to be sold, etc.

In addition to submitting orders to sell new securities, a primary offering feature or another feature may allow primary issuers to sell new securities in a mixed offering with securities that are not new, and also to repurchase securities from the trading market. In these instances, a process similar to that followed above with regard to the orders to sell primary shares may be followed. In addition, any buy back of securities may be controlled by an algorithm that ensures compliance with applicable rules for buying back securities, such as size, volume, timing, etc., limitations. Alternatively or additionally, the system 1000 may identify potential sellers for the repurchase based on seller sentiment. As noted above, seller sentiment may be derived from express statements from potential sellers as well as inferred from trade and non-trade information. For example, the system 1000 may obtain, from the buy or sell side of a trading or quotation platform or market, trade information to identify potential sellers of the primary issuer's securities. The system 1000 thereafter may present one or more identified potential sellers and pair the primary issuer and the potential seller or sellers for negotiations as discussed herein. The system 1000 may also similarly track the primary issuer's orders to repurchase securities and update the company's information accordingly. In addition to cash sales, the system 1000 may allow new securities to be exchanged for other types of securities. For example, a primary issuer may exchange new equity type securities for its own outstanding debt securities. The system 1000 may enforce any regulatory limitations for an exchange of securities. For example, the system 1000 may limit exchanges to new and outstanding securities issued by the same issuer, existing security holders, etc.

The system 1000 may further provide middle and back office functions carried out by an intermediary, facilitator and/or custodian for any aspect of trade support, settlement, and confirmations, e.g., using Extensible Markup Language (XML). Securities sold by a primary issuer according to the transactions described above may settle DVP (delivery versus payment) or DWACs (deposit/withdrawal at custodian service), and the securities may be transferred directly between the primary issuer or an agent of the primary issuer, and an investor or agent of the investor.

As noted herein, the system 1000 allows primary issuers to sell primary securities on an exchange and/or marketplace in a trading market without the services or intervention of an underwriter. Thus, although the party at risk of failing to sell the primary securities in this instance is the primary issuer, the primary issuer may delay or withhold further issuance of securities until such time as it is possible to sell the desired quantity of securities on a secondary market at the desired price or obtain capital in other ways. The primary issuer may therefore opt to use the services of an underwriter, which provides the issuer with a guarantee with regard to the primary offering.

As can be expected, the transaction costs for the primary issuer in trading directly on the trading market may be substantially lower than the transaction costs that would otherwise be incurred if the primary issuer used the services of a traditional underwriter to trade the primary shares and/or used other conventional means to trade primary securities.

The primary issuer may trade the new securities using any offer technique. For example, the primary securities may be offered for sale in the form of a market order, which is an instruction to sell the securities at the then current market price. A market order is usually executed quickly as long as there are active buyers in the market. The primary issuer may place a market and/or sell order without regard to the bid and ask spread. The buyer can agree to buy the security by the number of securities (e.g., the total number of shares of stock) or by a total or aggregate dollar value.

A limit order is used by the issuer to set a limit on the sell price, e.g., a lower threshold price under which the issuer is not willing to sell the security. A limit order is only executed when the buyer agrees to pay at least the issuer's limit.

A stop order can be used to set a limit under or over which no further primary securities are traded. The stop order can be used to discontinue trades of the primary issue if the price on the secondary market has fallen below a desired threshold. Stop sell orders are placed below the current market price and can be converted to a market order when the security price on the exchange reaches the stop order price.

A stop-limit order can be used to protect a foundation or floor price for the secondary security on the exchange. A stop-limit order turns into a limit order when the stop price is reached.

A day order provides a means by which the primary issuer can place a sell order, e.g., defined by minimum price or other conditions, that remains in effect for only a single day of trading.

A good until canceled order remains an open offer to sell the primary security at a fixed price until the order is filled or the offer to sell is withdrawn (e.g., canceled) by the primary issuer.

A fill or kill order can be used when it is desirable to sell a defined quantity of securities immediately. Thus, a fill or kill order is executed completely or not at all.

Other order types including any of trailing stop, trailing stop limit, one cancels other, contingent orders, triggers, market on close, and limit on close may be used by the primary issuer when selling the securities.

In addition to automated matching of orders, the system 1000 may allow users to negotiate the sale of primary securities on the trading market. In this instance, the system 1000 allows the primary issuer and investors/purchasers to exchange offers back and forth until an offer is accepted by one of the parties.

Primary issuers may use different types of intermediaries, facilitators, custodians and/or brokers to improve liquidity and/or take advantage of market conditions to sell amounts of primary securities. The intermediaries or brokers may provide any kind of transaction aid, such as block trading desks, security exchanges, auction forums, and electronic communication networks (ECN). Primary issuers may also divide orders over time and by destination into smaller sized orders to aid in liquidity. This may be done manually by the primary user or automatically by the system 1000. That is, the system 1000 may receive an order from the primary issuer and apply at least one algorithm thereto to break up the order into a number of smaller orders more likely to be executed automatically on an exchange.

Alternatively the primary issuer may use an automated order matching system or ECN for executing sell orders without disclosing to the marketplace the precise details of price, quantity, or type in order to avoid impacting the price in the marketplace. Large orders can thus be entered into an order matching system without depressing the price of the secondary securities.

In another aspect, the primary issuer may delegate placement and/or execution of sell orders to an automated computer trading system. Alternately the primary issuer may use a computer model and/or algorithm to determine selling opportunities, then manually or automatically completes the sale of securities. The automated system may use formulas for determining optimum times, price and quantity for selling the primary securities. A wide range of different types of evaluation models, computation methods, formulas and the like can be used to select selling opportunities and/or to execute sales. These systems may rely on pricing information that is internal (i.e., specific to the pricing for the secondary security on the exchange) or both internal and external (e.g., information that is external to the exchange such as interest rates). Typically, each strategy uses one or more internal or external data inputs, weighting factors, and pricing strategies such as spreads etc.

In one embodiment of such a model, the primary issuer inputs variables corresponding to the prices at which the primary issuer is willing to sell over a period of time, with each amount being initiated by the system by communicating offers automatically at different points on a schedule within that period of time. In another model the primary issuer determines executable and/or target pricing, quantity, and/or timing for orders to sell primary issues using a predetermined weighting factor and a generalized index value. A generalized index value can be provided by a preselected data source for a particular item in a particular field of operation, which can be represented by an index (e.g., data source, item, field, etc.). Another model drives an offer price or quantity by multiplying a weighting factor with a generalized index value and adding the result thereof to a second weighting factor. Offer prices and/or quantity could likewise be derived from a combination of weighting factors and/or constants in relation to one or more indexes (e.g., S&P 500). Further still a plurality of constant values, weighting factors, generalized indexes and/or other external data may be used to model the sales of the primary issue.

The models, formulas, strategies, etc. can be used to determine and/or specify the specific value of an order characteristic for order price, order quantity, timing, as well as an order satisfaction density profiles (e.g., to combine price and quantity guidelines/thresholds based on numeric thresholds or standards including, for example, choice of transaction destination, order matching system, segmentation of an aggregate order between multiple destinations, means of delivery, quality standards, credit standards, as well as many other conventional transaction related or financial instrument or commodity related characteristics). Models and algorithms such as those used for exchange-based derivative trading may likewise be used.

In one exemplary embodiment, securities of a primary issuer are offered for sale by the system 1000 in response to market indicators. The market indicators represent statistical, quantitative, and/or subjective inputs derived from the secondary market of the exchange on which the primary issue is traded. In a representative example, a primary issuer automates the sale of primary securities by programming their sale to a volume indicator. On days or during market periods when the sales volume of secondary securities corresponding to the primary securities and/or other statistically derived values keyed to the primary issue or other financial indicator falls below or above a threshold, the system 1000 may offer the primary securities for sale or the sale of the primary security may be suspended. In other embodiments the quantity of primary securities sold may be balanced such that certain ratios relating to the volume of secondary sales is maintained.

The sale of the primary securities may be set at levels such that the secondary market is essentially unaffected by the primary issuer's sale of primary securities, for example, by setting the volume of sales of primary securities to represent only a minor portion of the total volume of sales for the secondary securities, e.g., the sale of primary securities representing 0.1, 1, 2, 5, and/or 10% of the total volume of the corresponding secondary securities sold on the exchange. Likewise, the sale or offer for sale of primary securities may be keyed to certain price targets. If pricing for the secondary security on a secondary market falls or rises above the target, the sales and/or offer for sale of the primary security may be suspended or accelerated, as deemed most appropriate by the primary issuer. Primary securities may have sale targets likewise keyed or targeted to price spreads, opening highs, closing lows and the like.

A mediator, facilitator, or custodian acting on behalf of the primary issuer and one or more other primary issuers may develop an index describing the pricing and/or sales performance of primary securities on a secondary market. The sales performance may be used as an index or predictive measure of market strength or confidence in a primary issuer's financial success. The index or composite of primary issues may itself be used as a feedback data point in setting sales targets, such as sales price for any individual primary security.

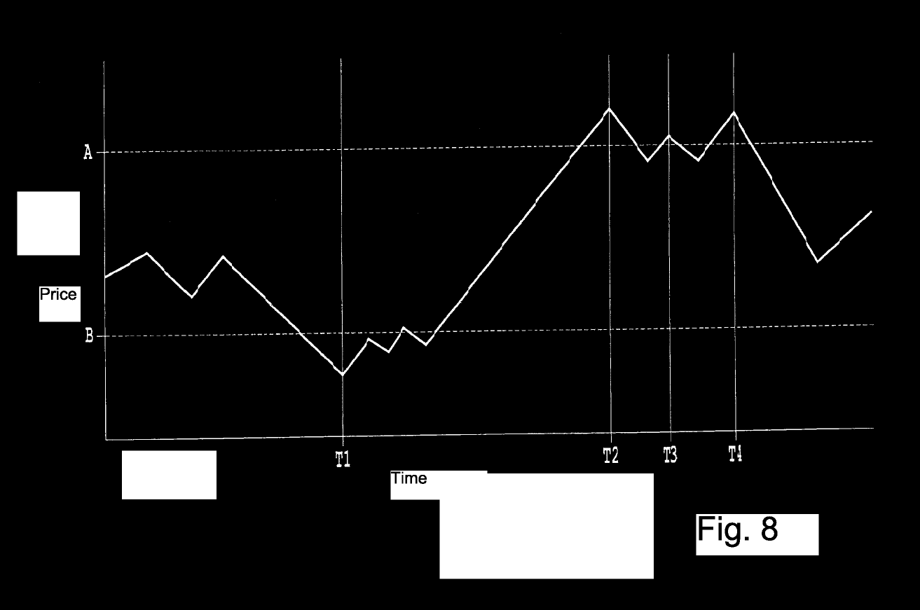

In another exemplary aspect, sales of primary securities may be carried out during market times and at market conditions, which are identified as conditions under which the secondary market is operating in conventional fashion. Such conditions may be keyed on volume, index performance, pricing spreads and/or any statistical derivation such as volatility or volatility indices. At certain times or under certain conditions, which are identified as stable market conditions, an automated system may be triggered to offer the primary security for sale on the secondary market. For example, as shown in FIG. 8, the system 1000 may set the price for an offer of the primary security based on one or more price levels of the security in the secondary market. The sale of new securities of a primary issue may be programmed or instructed to occur at any point when, for example, the market price is above a minimum (B) and/or over or under a higher threshold price (A). (T1) represents a period of a low trading price on the exchange for securities which correspond with and are indistinguishable from the primary securities of a primary issuer. Preferably the primary issuer does not sell securities at time (T1) because at such a time the market price is relatively low and the total proceeds of sales of the new issue will be minimized. On the other hand, the time periods (T2)-(T4) represent trading activity on the secondary exchange at which the corresponding secondary security is sold at a relatively high price, i.e., above the price threshold (A). The time periods (T2)-(T4) represent desirable opportunities for the primary issuer to sell and/or offer for sale primary securities.

### Registration Identification Feature

A registration identification feature according to an exemplary embodiment enables U.S. listed and unlisted public companies with effective shelf registration statements or WKSI eligible companies to receive bids from investors that the companies can act on. More generally, an exemplary registration identification feature identifies at least one party for one or more trades of securities, which would otherwise be limited, except for an action of the party with regard to a limitation that must be satisfied for the party to be legally authorized to trade the security. In one embodiment, the action of the party that legally authorizes the party to trade the security is the filing for and/or obtaining approval from a regulatory authority to trade the security. For example, the system 1000 may identify a primary issuer of new securities as being able to legally sell primary securities based on the primary issuer having filed a shelf or other registration, or performed any other step to obtain regulatory approval for an trade of the primary or other securities. As discussed herein, legal authority to sell primary shares may be regulatory, contractual, based on internal company, or listing or quotations standards.

Evidence of an effective shelf registration on file with the SEC generally indicates that the primary issuer is legally authorized to sell primary registered securities. The primary issuer, however, is not under any obligation to carry out the primary issue. For example, a primary issuer may obtain regulatory approval to sell new shares of stock or other securities from time to time. Thus, whether or not the primary issuer sells the new securities under the shelf registration is strictly up to the issuer. A shelf registration, therefore, is generally not an order or even an indication of interest to trade securities as the intent of the primary issuer to actually \ trade the primary issues within any particular time cannot be inferred therefrom.

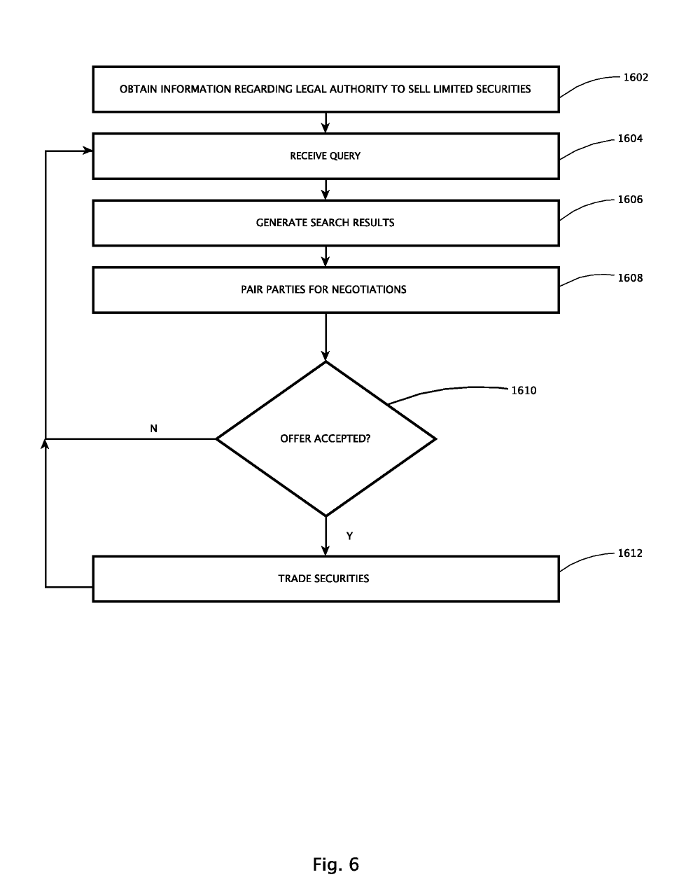

In one exemplary embodiment, the system 1000 obtains information regarding a party being authorized legally to sell securities and communicates that authority to another party that may or may not be interested in investing in the first party. The details under which this functionality may be provided may vary. Referring to FIG. 6, a method for providing a registration identification feature, as discussed herein, begins at step 1602 by obtaining information regarding a party being authorized legally to sell securities that would otherwise be limited. This information may be obtained in a variety of ways and from a variety of sources. For example, the information may be obtained from a company information database maintained by the provider as indicated above. That is, the provider may obtain from the primary issuer, during registration of the company or at any other time, information regarding whether or not the company has an effective shelf registration and any ancillary information, such as the type of shelf registration, the type of security, the maximum number of shares or size of primary offering, expiration of the shelf registration, etc., as well as any of the other data associated with the company noted above. Alternatively or additionally, the status of the primary issuer with regard to the shelf registration may be obtained from a source or third party provider, such as the EDGAR or any other SEC database, financial information services, such as Bloomberg™, email alerts regarding shelf filings, etc. This information may also be collected periodically, e.g., daily, etc., or on demand, in real-time or otherwise.

In an exemplary embodiment, the information obtained is compiled, and made electronically available over a communications network to other users of the system 1000 via a client device 1100. The information is preferably arranged such that the public and/or subscribers to the communications network may determine which companies have the legal authority to sell primary issues based on whether or not the company filed an applicable shelf registration or otherwise has an effective shelf registration, and/or performed any other step that gives the company the legal authority to sell securities. The information may further include details describing whether or not the primary issuer's shelf filing included a placement agent and/or an underwriter.

The system 1000 may allow investors or any other system user to identify companies authorized legally to sell securities. This may be achieved by providing investors with an interface with at least one form element therein that allows users to specify terms of the query and to submit such queries received by the system 1000 at 1604. In response to the query, the system 1000 returns to the user results relevant to the query at 1606. In an exemplary embodiment, the system 1000 queries the company database and identifies therefrom companies authorized legally to sell primary issues based on an indication in the database that the company has an effective shelf registration on file with the SEC. The system 1000 may allow users to search companies alternatively or additionally by various factors, such as name, symbol, market capitalization, sector, industry, etc., as well as variables relating to the regulatory approval. For example, the system 1000 may further provide an interface for the user to include in the query variables relating to the beginning and expiration of a shelf registration, the type of securities stated in the registration, and the size of securities/offering. In this respect, the system returns results that fit within the time, size, and type factors specified by the user in the query. In lieu of the system 1000 retrieving queries from investors directly, the system 1000 may match investors to primary issuers based on an investor profile that indicates preferences with regard to investing in primary securities and prompts the investor and/or the primary issuer to begin negotiating a trade. The user profile may be compiled from interests specified by the investor or inferred from the investor's trading history. Alternatively or additionally, these steps may be performed through an intermediary that matches interests and prompts each of the investor and/or primary issuer to begin negotiations.

The system 1000 may also identify potential buyers based on buyer sentiment and present to one or more of the primary issuers with an effective shelf or other registration information regarding one or more of the potential buyers identified. As noted above, buyer sentiment may be derived from express statements from potential buyers as well as inferred from trade and non-trade information associated with the potential buyers. For example, the system 1000 may obtain, from the buy side of a trading or quotation platform or market, trade information to identify potential buyers of primary issuers' securities. The system 1000 thereafter may present information regarding the one or more identified potential buyers to the primary issuer, for example in an interface screen, and pair the primary issuer and the potential buyer for negotiations as discussed herein.

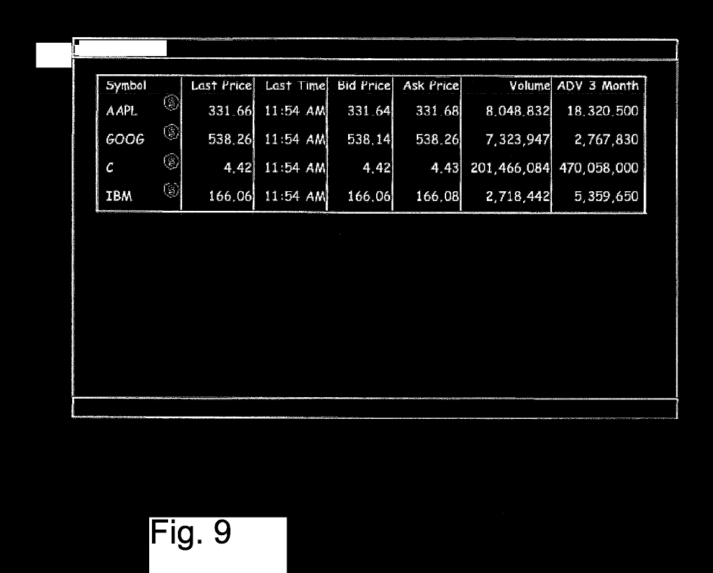

The results of the query may be displayed in a search results listing, such as the interface screen shown in FIG. 9, which may include a listing of one or more primary issuers authorized legally to sell based on shelf registration status. The results of the list may be sorted based on relevance to the search and/or overall willingness or probability to trade based on trading history as indicated below. The shelf registration status may be shown in the list with an icon (S) near the name or symbol of the company as shown. In addition to the name of the primary issuer, financial and/or market information may also be provided in the listing, such as the market price (real time or delayed), the bid-ask spread, volume, daily volume, the number of authorized primary securities that the company is able to sell, etc. The listing may also include companies authorized legally to sell as a result of any other action other than a shelf registration. In this instance, the listing may include such companies without an icon or with a different icon. In at least one embodiment, a ticker symbol is created for one or more of the primary issuers identified as discussed herein as being authorized legally to sell primary securities based on shelf registration status and the ticker symbol created can be listed on a trading or quotation platform or market with other securities. In at least one embodiment, the identity of a particular primary issuer is not revealed until the investor agrees to maintain the identity and/or any other information associated with a shelf registration in confidence. In this instance, one or more of the companies may be listed in the results with a generic ID, such as COMPANY 1. By selecting the ID of the company, a non-disclosure agreement may be displayed in response with form elements for the investor to accept or reject the terms of the agreement. Once accepted, acceptance is noted in a database entry associated with the investor and/or the company, and the confidential information is revealed.

In addition to providing general research capability regarding whether a particular company has filed for regulatory approval for a primary issue, whether approval has been obtained, and/or whether the approval included a distribution agreement, the information compiled may be used by the system 1000 to identify primary issuers with the ability to sell new securities. In this respect, the system 1000 provides prospective investors with a means by which to search for and identify companies that are able and thus may be willing or inclined to make shares of new securities available under negotiated conditions. For example, a prospective investor wishing to purchase a large block of shares may be willing to negotiate a discount or accept a premium to the secondary market price of such shares by purchasing a large quantity thereof. A large block of shares is generally regarded to be an amount of over 10,000 shares of equity and/or over one million dollars in aggregate value. By carrying out the sale of a primary issue in large blocks, a primary issuer may reduce transaction costs and improve the overall efficiency of the primary issue, thereby increasing the proceeds available to the primary issuer. In exchange for such efficiency the primary issuer may be willing to negotiate certain conditions of the sale of new shares of stock or other securities in a large block to one or more investors. The conditions of sale may include pricing, size, documentation, warrants, notes, and the like.

Once identified, the system 1000 may pair the parties for negotiations at 1608. Pairing entails allowing the users of the system 1000 to communicate messages between each other for the sale of the primary securities. The negotiation generally involves the potential investor communicating a first message via the system 1000 to the primary issuer. The first and any subsequent message may or may not be an offer that may be acted on. For example, the first message may be an invitation to negotiate with no or fewer than all terms specified therein, or may include all of the terms of an offer. Offer and counter offer messages may be communicated back and forth between the parties until at 1610 there is an acceptance of one of the offers by a party or cancellation of the negotiations. An offer that is accepted results in a trade of the primary securities at 1612. The system 1000 may repeat the steps discussed herein as shown. The system 1000 may also allow the parties to access the workflow collaboration feature or a portion thereof to close the deal after negotiations or in lieu of negotiations. For example, once paired, parties may negotiate the transaction through the workflow collaboration feature and use the standard document templates and may generate custom documents as necessary to complete the transaction.

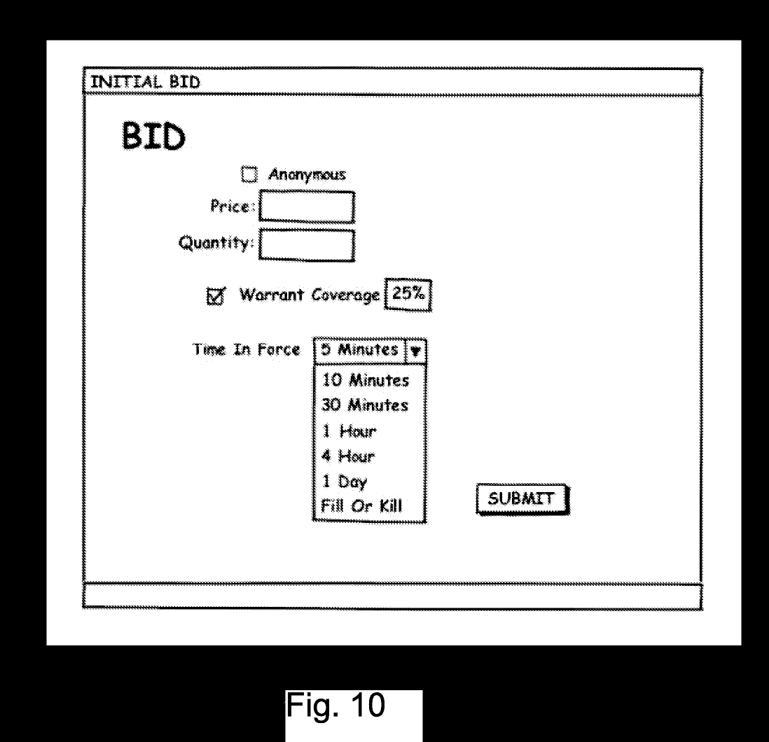

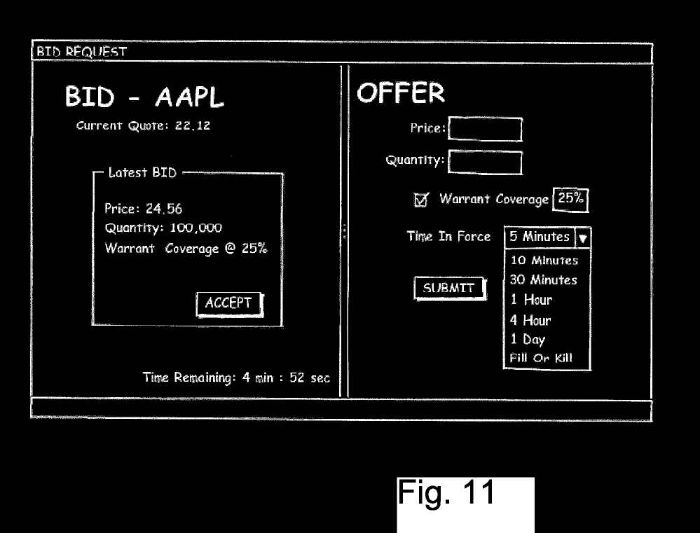

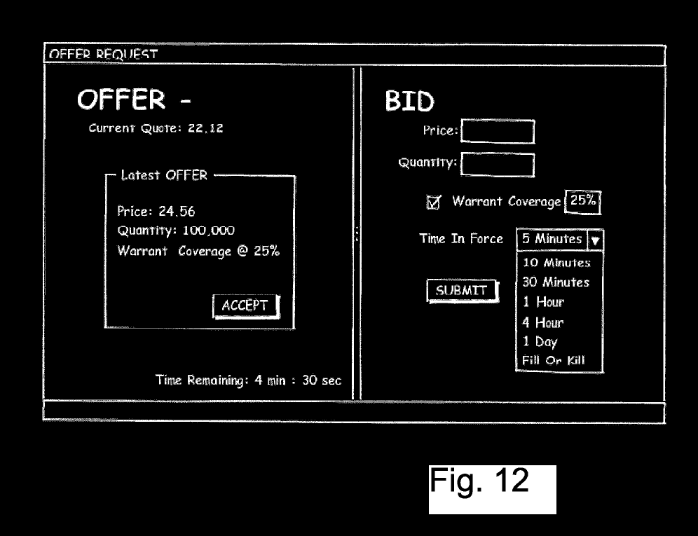

In at least one embodiment, messaging between the investor and the primary issuer are accomplished via one or more interface screens with form elements therein for the users to specify one or more terms of the offer/counter offer, accept or reject an offer, and/or to cancel the negotiation. For example, a first interface screen, such as the interface screen shown in FIG. 10, may be a screen for the investor to specify an initial bid for the primary securities, which screen may be displayed in response to an indication from the investor that he or she wishes to initiate a negotiation session with a company shown in the search results. The first interface screen may include form elements to specify one or more terms of a bid for the primary securities, such as a price, quantity, whether or not warrant coverage is desired and the percentage covered, and/or a time that the bid/offer will be in force. The system 1000 thereafter provides counteroffer interface screens with form elements therein for the users to view the terms of the offer (bid/ask), specify terms of a counteroffer (ask/bid), and accept or reject an offer (bid/ask), as shown in FIGS. 11 and 12. Offers not acted on within the time frame specified in the offer may be deemed rejected. In certain instances, a party may be able to submit a counteroffer after the time for acceptance specified in an offer has lapsed.

By negotiating new shares of stock or other securities through the system 1000, as noted above, the transaction may settle DVP (delivery versus payment) or DWACs (deposit/withdrawal at custodian service), and the securities may be transferred directly between the primary issuer or an agent of the primary issuer and an investor or agent of the investor. The system 1000 therefore may further allow the primary issuer to sell shares of stock or other securities of a primary issue directly to one or more investors. Such direct sales provide a convenient and efficient manner for a primary issuer to sell shares of stock or other securities at conditions which are favorable to primary issuers and investors buying such shares, while reducing any costs associated with intermediaries being involved in the transaction. Since the costs are reduced, the primary issuer may be willing to accept a lower price than would otherwise be acceptable, further improving liquidity for the primary issuer. Similarly, the investor may be willing to pay a premium for such securities. For example, the primary issuer may be willing to agree to a discount or the investor to agree to a premium relative to the prevailing market price. The discount/premium may vary according to the circumstances. The discount/premium may be any fixed discount or may represent a fractional or percentage amount reduction in price on a per share basis, e.g., a reduction of 0.01, 0.05, 0.1, 0.2, 0.5, etc. % relative to the market price of the security. The discount/premium may be reflected in the negotiated price or the system 1000 may apply the discount/premium separately.

An investor may wish to make an offer to the primary issuer with any term, such as the number of new shares of stock or other securities, documentation, riders for subsequent offers etc., and per share price, the documentation for some of which may be prepared using the workflow collaboration feature discussed below. The investor may wish to make such an inquiry or offer to the primary issuer in an anonymous fashion over the communications network. By making the inquiry anonymously, the investor may be presented with the advantage of anonymity, meaning that the primary issuer will not prejudice any decision to sell new shares of stock or other securities based upon the identity of the prospective investor. Alternatively, this information may be made available to the public and/or only the counter parties.

In an exemplary embodiment, as noted above the prospective investor and primary issuer may negotiate the terms and conditions of a sale of new shares of stock or other securities. For example, upon receiving an offer to purchase new shares of equity from a prospective investor at a preset price and/or amount or other applicable terms and conditions, covenants, options, etc., the primary issuer may respond with a counter offer changing any of the conditions of the prospective investor's offer. The counter offer may include a different, higher or lower, per share price or may otherwise effect or change the conditions of the sale or transfer of the new shares of securities from the primary issuer to the prospective investor.

In another embodiment, one or more of the prospective investor and the primary issuer may wish to carry out direct negotiations with each other outside of the system 1000. The administrator of the communications network may arrange such direct communications outside of the communications network upon request and mutual agreement of each party. Any agreement in terms of the terms of the trade may be entered into the system for trade settlement.

In one exemplary embodiment, pricing or conditions of sale of securities of the primary issuer are premised on formulas. For example a prospective investor may offer to purchase a block of shares from a primary issuer under conditions where the price is dependent upon quantity. The prospective investor may communicate an offer in which the price per share includes a discount that is related to the quantity of shares transferred. The prospective issuer's offer may give a first price under the condition that the primary issuer makes available sufficient shares of primary securities to complete the entire offer. The offer may further specify that the price paid and/or amount will have different levels depending on the quantity of shares dedicated to the transaction by the primary issuer. In order to strengthen the prospective investor's negotiating position such offers may be limited in time or duration and may be binding. The system 1000 therefore preferably provides messaging capability for users to specify and/or compute the variables associated with these or any other types of offers and counter offers disclosed herein.

In other exemplary embodiments the offer or counteroffer may include a formula that determines the price at which primary shares of securities are transferred from primary issuer to investor based on a discount or premium applied to the market price of the primary security on the secondary market.

### Block Identification Feature

A block identification feature according to an exemplary embodiment enables holders of concentrated positions in U.S. listed and unlisted public companies to receive bids from buyers that the holder can act on.

Generally, an exemplary block identification feature identifies at least one party holding one or more concentrated positions in securities. The party with a concentrated position may be, for example, an insider, or any other party. As with the registration identification, evidence that a particular party has a concentrated position in one or more securities may imply a willingness to sell securities, in blocks or otherwise, under certain conditions. The system 1000 preferably identifies parties that may be willing to sell by identifying parties having concentrated positions in securities. In identifying such parties, the system 1000 may also consider other variables as well, such as whether the holder is an issuer and whether the securities consist of primary securities. In these cases, the system may require that the party also be authorized legally to sell shares before identifying the party as a potential party for a trade. Other variables associated with a party holding concentrated positions in securities may be used to infer a willingness to trade blocks of securities, such as the party having a history of trading blocks of securities and/or the temporal relationship of any prior block trades. That is, blocks of securities traded more recently may indicate more of a willingness to trade blocks of securities than blocks traded in the distant past.

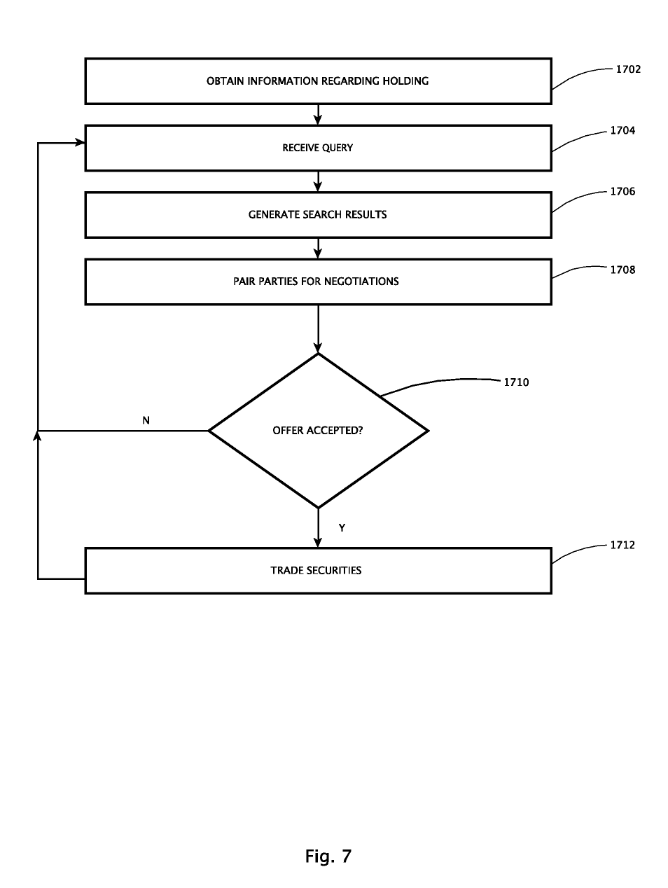

In one exemplary embodiment, as with the exemplary registration identification feature described above, the system 1000 obtains information regarding a party's holdings and communicates this information or information related thereto to another party that may or may not be interested in purchasing securities in blocks or otherwise. The details under which this functionality may be provided may vary as well. Referring to FIG. 7, a method for providing a block identification feature, as discussed herein, may begin by obtaining information regarding a party's holdings at step 1702. This information may be obtained in a variety of ways and from a variety of sources. For example, the information may be obtained from a user information database and/or a company information database maintained by the provider as indicated above. That is, the provider may obtain securities holdings information during registration of a user and/or a company, and/or from trading history that would indicate that a party holds a concentrated position of securities. Alternatively or additionally, the status of the party with regard to holdings may be obtained from a third party provider, such as the EDGAR or any other SEC database, financial information services, such as Bloomberg™, etc. This information may be collected periodically, e.g., daily, etc., on demand, upon registration of a company or an individual for access to the system 1000, etc.

As noted above, an exemplary embodiment of the system 1000 may allow potential purchasers or other system users to identify holders with a willingness to sell one or more blocks of securities being held. This may be achieved by providing users with an interface with at least one form element therein that allows users to specify terms of one or more queries and to submit such queries that the system 1000 receives at 1704. In response to the query, the system 1000 returns to the user results relevant to the query at 1706. The results returned generally consist of at least one holder of a concentrated position of securities relevant to the query.

As with the registration identification feature, the system 1000 may also identify potential buyers based on buyer sentiment and present information to one or more of the holders of concentrated positions regarding the one or more potential buyers identified. As noted above, buyer sentiment may be derived from express statements from potential buyers as well as inferred from trade and non-trade information associated with the potential buyers. For example, the system 1000 may obtain, from the buy or sell side of a trading or quotation platform or market, trade information that the system 1000 uses to identify potential buyers of the securities held by particular holders. The system 1000 thereafter may present the information regarding the one or more identified potential buyers to the holder, for example, in an interface screen, and pair the holder and the potential buyer for negotiations.

The system 1000 preferably allows users to search for holders having concentrated positions by various factors, such as company name, symbol, market capitalization, sector, industry, etc. In this respect, the system returns results that fit within the terms specified by the user in the query. The results themselves may be sorted by relevance to the query and/or willingness. That is, holders that would be more willing to trade may be returned higher up or generally more prominently in the results than ones with less of a willingness to trade. Willingness may be inferred from concentration and/or trade history. For example, an investor may submit a query for holders of ABC securities. In this instance, the system 1000 may return a list of holders having concentrations of ABC securities. For example, the system 1000 may return up to a threshold number of holders, such as the top 10 holders of concentrated positions in ABC securities. The listing may also include primary issuers identified based on their ability to sell and/or their willingness to sell as discussed herein. The results may be displayed in a listing, such as the listing shown in FIG. 9 with or without an indication that the securities are primary securities, market information, and/or the name/symbol and the size of the holding. In lieu of the system 1000 retrieving queries from users directly, the system 1000 may match investors to securities holders based on investor/holder profiles that indicate preferences with regard to selling and purchasing securities in blocks or otherwise, respectively, and prompt the parties to begin negotiating a trade. The user profile may be compiled from interests specified by the investor and/or securities holder, or inferred from the investor's/holder's trading history. The system 1000 may similarly identify investors in response to a holder query and return relevant investors thereto in response to the query. Alternatively or additionally, these steps may be performed through an intermediary that matches interests and prompts each of the purchaser and/or holder to begin negotiations.

Once identified, the system 1000 may pair the parties for negotiations at 1708 as discussed above with regard to the registration identification feature. In this instance, one of the parties initiates the negotiation by communicating a first message via the system 1000 to the other of the paired parties. Offer and counter offer messages via offer/counteroffer interface screens, such as those shown in FIGS. 11 and 12, may be communicated back and forth between the parties until at 1710 there is an acceptance of one of the offers by a party or cancellation of the negotiations. An offer that is accepted results in a trade of the securities being negotiated at 1712. The system 1000 may repeat the steps discussed herein as shown. The system 1000 may also allow the parties to access the workflow collaboration feature or a portion thereof to close the deal after negotiations or in lieu of negotiations. For example, once paired, parties may negotiate the transaction through the workflow collaboration feature and use the standard document templates and may generate custom documents as necessary to complete the transaction.

A sale of such securities may occur privately or publicly. Preferably, the sale securities are initially negotiated privately through the system 1000. There may be no restriction or condition on sales that may be carried out at prices that are higher or lower than the price of the underlying shares on the trading market. In this embodiment, the transfer or sale of large blocks of securities may be undertaken without disrupting the liquidity or pricing of the securities on the trading market.

In addition to maintaining a database of holders of concentrated positions, the system 1000 may maintain a database of particular buyers of blocks of securities or investors, such as institutional buyers and mutual funds. The database of investors may include information regarding the identity of the investor, contact information, and preferences with regard to investing, such as preferences with regard to sector, market capitalization, rate of return, trading history, etc. In this instance, the system 1000 may match investors against holders of securities. For example, if a particular security being held is expected to meet the threshold investment rate of return for a particular buyer, the buyer and the holder of the security may be matched to initiate negotiations towards a block sale of security held.

As noted herein, the registration and block identification features may be accessed by investors or any other user through a common portal or interface. In this instance, a generic interface screen may be provided that allows users to specify one or more terms for a search of relevant holders of securities. For example, the interface may include one or more form elements for the user to specify company name, security type, sector, geographic region, market price, trading volume, market capitalization, etc., or a combination thereof. In response, the system 1000 may compile a list of holders and/or potential buyers of one or more securities relevant to the query. As the query does not have to be limited to variables, such as primary issues and/or holders having concentrated positions, the list returned may include a combination of potential sellers, including primary issuers and holders having concentrated positions, other sellers, potential buyers, or a combination thereof. The system 1000 may also allow sellers to search for potential buyers in a similar manner.

### Comparable Investment Identifier Feature

A comparable investment identifier feature according to an exemplary embodiment identifies securities that particular parties may be interested in based on the parties' previous actions and the parties' own inputs. As discussed above, an exemplary system may suggest to particular users parties that may be of interest for a trade of one or more securities based on information that infers a sentiment of the particular user with regard to one or more securities. Suggestions may be provided in different contexts. Suggestions, for instance, may be provided in one or more electronic messages that include one or more potential parties for a trade based on the inferred sentiment of the investor. For example, the system 1000 may infer a positive sentiment with regard to companies in a particular sector and market capitalization based on the investor's interactions as discussed above and may suggest companies within the sector and market capitalization. The system 1000 may derive sentiment from express statements from potential buyers or sellers as well as inferred from trade and non-trade information associated with the potential buyers or sellers. For example, the system 1000 may obtain buy or sell side trade information from a trading or quotation platform or market and the information obtained may be used to infer sentiment from pending as well as executed or cancelled orders. The system 1000 may generate a list of companies that match the investor's sentiment and identify for the investor only companies likely to sell securities as discussed below.

### Conditional Indication of Interest Feature

A conditional indication of interest feature according to an exemplary embodiment enables investors to enter market sentiment, including an indication of interest with one or more unmet conditions, that a company may monitor. In an exemplary embodiment, the system 1000 allows users to send unsolicited messages to potential buyers or sellers with a conditional interest therein in buying or selling securities. For example, an investor may select a seller from a list of potential sellers and send a message to the potential seller using the system 1000 with a note that the investor may be willing to purchase a certain number of ABC securities if the seller would trade the securities held if one or more unmet conditions occurred. The message may be acted on or ignored by the receiving party. If the party receiving the message is interested, the receiving party may begin a negotiated trading session with the party that sent the conditional interest. The party receiving the message may also take the action necessary to satisfy the condition specified in the message, if within the party's ability to do so. For example, a potential buyer may send a conditional indication of interest to a primary issuer that includes a condition that the buyer would be interested if the primary issuer had an effective shelf registration. In this instance, the primary issuer may undertake to file the necessary registration to satisfy the condition. It is understood that a buyer may specify any condition for the trade of securities, including conditions that are not dependent on market variables, such as price, volume, etc. If the transaction involves non-standard terms, the documents necessary to complete the transaction may be prepared with the workflow collaboration feature as discussed below. Additionally or alternatively, the system 1000 may allow, for example, company and a party that communicated a conditional indication of interest to the company to complete the transaction as an unregistered offering using the workflow collaboration feature as discussed below.

The system 1000 may also generate conditional indications of interest based on one or more buyers' sentiment with regard to a particular security and communicate the interest to potential sellers. For example, a buyers' sentiment with regard to Company ABC may be inferred from the buy side information of a trading or quotation platform or market and such interest may be communicated to a primary issuer that may not have an effective shelf registration at that time that at least one potential buyer exists that may be interested in buying primary securities from the company if the company had an effective shelf registration. The system may aggregate conditional interests of a plurality of potential buyers and present the aggregate to the primary issuer.

In certain instances, a database of potential sellers may be maintained that includes potential sellers registered and potential sellers not registered with a platform that provides one or more of the features discussed herein. In these instances, the system 1000 may aggregate unsolicited conditional interests for registered and unregistered potential sellers and provide the aggregate information to a terminal associated with an agent of the provider. If sufficient aggregate interest exists, the agent may thereafter contact particular unregistered potential sellers in an effort to register potential sellers with the platform. Once registered, the conditional interest messages may be communicated to the potential seller for consideration and/or negotiation. The system 1000 may provide an interface screen that highlights potential sellers with the greatest conditional interest. For example, the sellers receiving the highest number of conditional messages may be listed more prominently than sellers having less conditional interest messages. Similarly, the number of securities specified in the conditional messages may be added together to give a potential volume of trades should the condition or conditions specified be satisfied. Prominence may be shown in an interface screen with different colors, fonts, etc., or by sorting a list of sellers based on the number of conditional messages, potential volume, or a combination thereof. Aggregate conditional interest may also be charted over time or any other variable. For example, the system 1000 may generate a chart showing relative conditional interest of a particular company for the past day, week, month, etc. The likelihood of the condition being met may also be taken into account when determining conditional interest. For example, messages with conditions not likely to be met may be filtered out or given less weight when determining the aggregate conditional interest for a company. Sentiment may be derived and updated in real time.

### Workflow Collaboration Feature

A workflow collaboration feature according to an exemplary embodiment provides a collaboration tool for users thereof to manage workflow and compliance in originating, marketing, processing, and/or closing aspects of transactions. Generally, an exemplary workflow collaboration feature provides a workflow platform that facilitates securities placements.

A private placement is generally a sale of securities to a relatively small, select group of investors. Private placements of unregistered securities are generally referred to as Private Investment in Public Equity (“PIPE”) whereas private placements of registered securities are referred to as Registered Direct (“RD”) offerings. Both are confidentially marketed offerings of equity or equity linked securities, which may include warrants. Various types of registered and non-registered securities may be sold in a private placement, including equity and debt securities, derivatives, etc., or a combination of securities and unsecuritized obligations. The terms of a private placement and the documentation supporting the placement may therefore vary between placements. Although the workflow collaboration feature is discussed herein by way of example with regard to private placements, the workflow collaboration feature may be used in other securities placements, including without limitation, IPOs, secondary offerings, follow-on offerings, confidentially marketed public offerings (“CMPOs”), etc.

A workflow collaboration feature, in at least one exemplary embodiment, facilitates such placements by providing a service or services that allow issuers and investors to be more efficiently matched with each other, and by providing an interface for issuers, investors, and any intermediaries to negotiate the terms of a private placement and generate the documentation supporting the placement. In the context of an exemplary workflow collaboration feature, issuers are companies that are looking to sell securities and institutional or other investors looking to buy securities. Each of these parties may be represented by or work with agents, such as issuer's counsel, auditors, investment relations firms, investor's counsel, etc. A provider of the feature may also involve one or more intermediaries for any placement handled through the workflow collaboration feature. For example a placement agent may control the workflow for a particular investment project. In an exemplary embodiment, the system 1000 maintains a database that includes data associated with these users, such as a user ID, user name, company, role with the company, status information, e.g., indicating whether a particular user has agreed to the terms of the investment project, including a non-disclosure agreement, etc. The database for a workflow collaboration feature may be populated when an issuer, investor, or any other user registers for the system and/or when they are using the platform for the first or any subsequent time. Alternatively or additionally, an agent of the provider may enter the information into the system 1000.

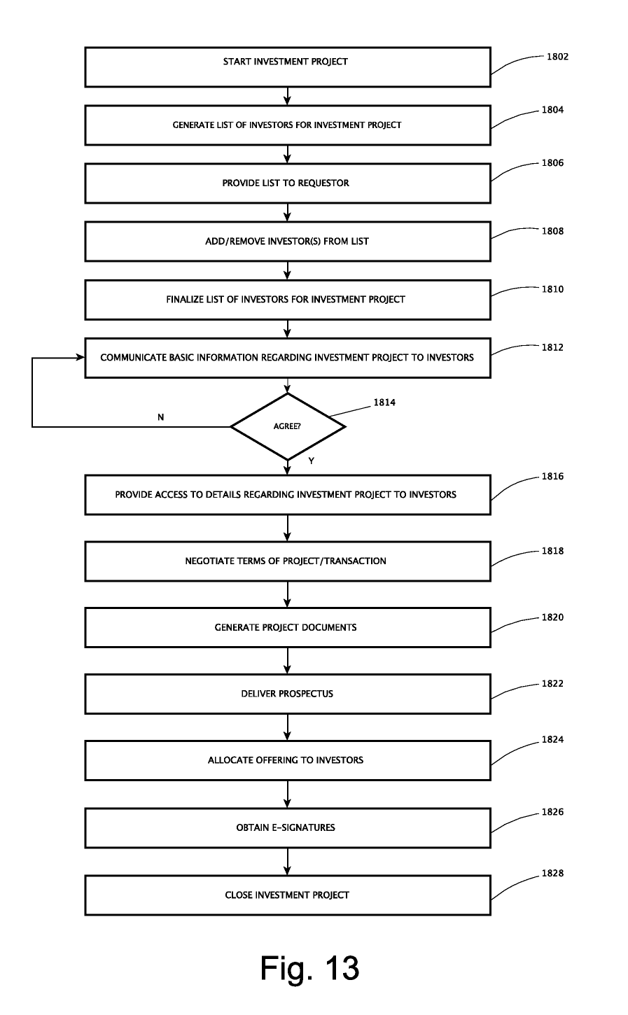

Referring to FIG. 13, in one embodiment, a workflow collaboration feature may be initiated with a placement agent and an issuer engaging one another to start an investment project at 1802. The start of an investment project generally includes creating a new record of investment project in a project database and specifying the relevant details regarding the investment project, such as the placement agent responsible for the project, the identity of the issuer, relevant sector or industry, geographic location, exchange, market capitalization or range, size or range of the offering, trading volume or range thereof, a working group list of parties involved in the investment project, etc. Some or all of the information for the project database may be obtained from the company information database or from information available publicly. Thereafter, the system 1000 and/or the placement agent may query a database of investors, such as the investor database noted above, and identify therefrom a list of investors that may be interested in the particular investment project at 1804. Alternatively or additionally, the system 1000 may identify investors that may be interested in a particular investment project automatically based on investor sentiment as discussed herein or otherwise. For example, the system 1000 may identify investors with express sentiment or inferred sentiment with regard to the particular primary issuer or a company similar to the primary issuer associated with an investment project.

In at least one embodiment, the system 1000 allows placement agents to engage in a book building process. That is, the system 1000 may allow the placement agent to collect indications of interest from investors at various prices, within a price band specified by an issuer. Investors may revise their indications of interest up until final allocations are confirmed. After a certain period of time, the book is closed and a price is determined based on demand for the securities. The placement agent may allocate the securities thereafter to investors accordingly.

The system 1000 may, in response to a query or automatically, generate a list of investors relevant to the query or that otherwise have interests or sentiment that matches the investment project. The list may be provided to the placement agent or another requesting user, e.g., in an interface screen, at 1806. The system 1000 may allow a placement agent to remove investors from the list identified by the system 1000 and add investors to the list that were not identified by the system 1000. If at 1808 investors are added or subtracted from the list, the system may regenerate the list or otherwise finalize a list of investors at 1810.

Once a list of investors has been assembled, an email or other form of message may be sent by or through the system 1000 to the selected investors at 1812. For example, one or more messages may be displayed to investors when the investor logs into the system 1000 inviting the investor to consider a particular investment project. The message preferably contains basic information regarding the investment project or transaction, but does not include information that would identify the particular issuer of the project. For example, the message may include the sector to which the issuer belongs, the geographic location, an exchange on which the issuer is listed, a market capitalization range, a 30 day average daily trading volume, etc. At this stage, the issuer on a particular project is anonymous, and the identity of the issuer and the details of the project will not be provided to any investors unless one or more of the investors agree to maintain the information regarding the project in confidence and to go “over-the-wall”. The system 1000 may provide a mechanism for investors to agree to go over the wall. This may be accomplished with a link included in the project email or electronic message that when selected allows investors to agree to a non-disclosure and non-use agreement applicable to the specific project. For example, by selecting the link the system may cause an agreement to be displayed with a button or buttons therein for the investor to accept or reject the agreement. The agreement may therefore require the investor to maintain the project information confidential and may further require the investor not to use or otherwise trade on any of the project information obtained as a result of the going “over-the-wall” until the information becomes public.

Thus, if at 1814 the investor accepts the agreement, the system 1000 may note the status of the investor regarding the non-disclosure and non-use agreement, e.g., in the project or other database, and allow the investor at 1816 to access additional information and/or features regarding the particular investment project. For example, the investor may be given access to the identity of the issuer, a draft term sheet, a virtual road show, standardized documents or document templates, secure data room, research reports, company filings, instructions, solicitation and marketing materials, legal documents, request a call with management of the issuer and/or the placement agent, etc. In at least one embodiment, the system 1000 will not make the identity of other investors available to investors nor will investors be able to speak or otherwise communicate with other investors through the system 1000. Additionally, the system 1000 may limit direct contact between investors and issuers through the system 1000 unless the placement agent is also involved in the communication. The system 1000 preferably maintains auditing information that includes user interactions with the system 1000, such as the time and date that each investor agreed to go over-the-wall with a particular project, offers and counteroffers made and/or accepted, access to information and/or documents, messages sent/received, document revisions, etc.

Once one or more investors agree to go over-the-wall, those investors may negotiate the terms of the placement at 1818 with the placement agent via the system 1000 or directly. For example, the workflow collaboration feature may include an instant messaging feature that allows investors and/or the placement agent to negotiate the terms of the placement. The instant message trail may be stored with the project information. Some or all of the communications may also be performed via telephone.

A single investment project may include multiple transactions. That is, a placement may include sales of securities to a plurality of investors in one or more separate transactions. Each transaction may be negotiated with different terms and have different documentation supporting the transactions. In this instance, an embodiment of the system 1000 may provide access to the terms of a transaction and any documentation only to parties involved in the transaction, such as particular investors and the placement agent, and investors who are not parties will not be able to access that transaction information. The system 1000 may provide this separation with a transaction database, which includes information for each transaction of a project. For example, the transaction database may associate the particular investment project with one or a plurality of the transactions for the project, the parties to the transaction and the placement agent assigned to the project, etc. The negotiated terms of the transaction, messages, standard and non-standard documentation, document templates, custom documents, amendments to the documents, etc. may then be associated with a particular transaction.

As noted above, the investment project and/or a transaction thereof may relate to a plurality of securities. For example, a transaction may include the sale of warrants that give the buyer of the warrant the right to purchase primary issue securities at a predetermined price prior to, during and/subsequent to the issuance of the securities on an exchange and/or marketplace. The warrants may be used as an inducement for the sale of other securities. That is, the primary issuer may offer for sale debt securities offering a certain rate of return and, in addition, warrants that entitle the holder to purchase an upcoming or concurrent primary issue at a predetermined price or at a price that is a preset fraction of the actual issuance price of the primary issue. Consequently, the parties may negotiate the types of securities included in the transaction and the terms thereof The types of securities sold in one transaction may therefore differ from another in the same placement and the documentation correspondingly differ between transactions.

In an exemplary embodiment, system 1000 makes available a plurality of standard documents that parties and/or the placement agent may use in a transaction. The documents may be in the form of a template with fields that are populated by the system 1000 based on terms negotiated by the parties and/or the placement agent. For example, standard document templates may include fields for party names, terms of the transaction, such as the type or types of securities being sold, price, any relevant dates, signatures, etc. The system 1000 may also allow a placement agent and/or parties to upload non-standard or custom documents for a transaction, and to edit standard and non-standard or custom documents. Once uploaded/edited, the documents are generally associated with a transaction and are made available for review by the parties to the transaction. In one embodiment, only the placement agent and/or placement agent counsel may have the ability to see all the documents and any amendments thereto. Once finalized, the placement agent and/or the system 1000 may generate a final set of documents for the transaction at 1820. In certain instances, the transaction may require a prospectus supplement. The system 1000 may therefore generate the prospectus supplement automatically and deliver the supplement to investors electronically at 1822.

Thereafter, final documents may be posted and each investor may be given their allocations of the securities placement (e.g., the allowed number of securities available for purchase by the particular investor) at 1824. Preferably information regarding the allocations is available only to the individual investor and not any other investors involved with the placement.

An issuer and investor may execute documents electronically and electronic signatures may therefore be obtained at 1826. In an exemplary embodiment, the system 1000 populates signature pages in at least one of the documents with delivery instructions and/or wire/settlement instructions automatically.

Once all of the transaction documents for the deal are finalized, the placement agent may confirm that the total deal/investment project is subscribed and authorize crossing of signature pages. Thereafter, the system 1000 may generate closing instructions and communicate the instructions to the issuer for closing the deal at 1828. The closing instructions for the issuer may include a list of purchasers and their respective allocations, and settlement instructions. The workflow collaboration process discussed herein may be repeated for each investment project.

The system 1000 may integrate with a clearing firm for settlement of the transactions. That is, once allocations are memorialized, the system 1000 may communicate the allocation information to a clearing firm that settles the transaction accordingly. The system 1000 may communicate with existing settlement software via an application program interface (API) or otherwise.

In an exemplary embodiment, the system 1000 may maintain information in a database that includes information identifying primary issuers who may not wish to publicly sell securities or who may desire private placement of securities. In such instances, the system 1000 may allow prospective investors to search for such companies and may allow investors to make offers to purchase securities from the primary issuers in the manner described above.

The system 1000 also may match one or more investors with one or more investment projects by comparing confidential investor characteristics with confidential investment project characteristics. Non-confidential information may likewise be used. The matching may be carried out anonymously such that neither the investor nor the issuer associated with the investment project initially knows the identity of the other party. After an initial match between investor and investment project has been made, the identity of at least the first investment project/issuer may disclosed to the investor, optionally if the investor agrees to be bound to a non-disclosure agreement.

A transaction may include a plurality of specific tasks that are either computer automated or carried out by one or more individuals or groups. Such steps include assembling a working group list for one or more investment projects. Assembling a list includes identifying one or more investment projects according to one or more criteria. The investment projects may conform to criteria identifying a particular family of investment projects by type, such as equity investments, debt investments and/or illiquid investments such as accounts receivables. Investment projects may also be identified or assembled according to relative size, for example, investment projects requiring up to $1 million, investment projects requiring from $1 million to $2 million, investment projects seeking $2 million to $5 million. Investment projects may likewise be categorized in terms of industry (e.g., by SIC code) or by describing the group or individual offering the investment project in return for investment (e.g., charities, retirement funds, hedge funds, mutual funds, pensions funds etc.). For example, investment projects may be assembled by industry groups such as electronics, biotechnology, real estate and the like. Investment projects may be categorized according to the group or individual organizing or mediating the legal aspects of the investment project, such as an investment bank, an investment company, an institutional investor and the like.

The working group list preferably includes a mediator, such as a placement agent. The working group list may not need to include each individual or employee of the issuer or mediator. The working group list may be categorized by issuer and mediator, each of which is further categorized to the level of functionality or particular individual included on the list. For example, particular individuals may be identified by name or function, e.g., controller, chief financial officer, chief technical officer and the like. The working group list may also be assembled according to individuals or groups representing any of the issuer, of the investment project, or a mediator. Such individuals representing any of the aforementioned parties may be attorneys or other parties acting on behalf of the issuer, investment project, or mediator. The attorneys or legal representatives may be the same as those attorneys who prepare and/or amend any documents necessary to carry out the transaction.

The working group list generally identifies those individuals, parties or groups who may later be given permission, clearance and/or authority to view proprietary or private information from any of the parties involved in an investment project.

Assembling the working group list may be carried out before any private or proprietary information is exchanged between parties, e.g., in the absence of investors. The working group list may be expanded, amended or shortened as a transaction is developed and concluded. An initial working group list may include only those individuals or groups of parties necessary to confirm that further contact and exchange of information between groups is warranted. The working group list may therefore have degrees and stages identifying particular individuals, groups or functionalities of the parties who are entitled to view and/or exchange proprietary or private information between the parties. In one embodiment, the working group at least initially includes parties other than investors.

Exemplary embodiments may include one or more steps or stages in which due diligence information is gathered and, optionally, verified. Due diligence information includes both financial, legal, marketing, and technical information that is considered private or proprietary by any of the parties and/or which may be publicly available. The gathering of due diligence information may be carried out by the mediator or a third party subject to a nondisclosure agreement with any of the mediator, investment project or investor.

Due diligence information may be gathered by, for example, requesting a submission of the same from the parties and may be gathered in one or more stages. Initial stages may collect due diligence information that describes only, for example, the financial performance and projected financial performance of a particular issuer or investment project. Other stages of due diligence information may include, for example, customer lists, marketing plans, profit and loss statements, warranties and declarations of individuals involved in the transaction. In one embodiment, a mediator gathers due diligence information from an issuer prior to the identification of a particular investor or group of investors. The due diligence information may be gathered such that a template of information is completed either by the issuer, or by an individual obtaining information from the issuer to, complete a due diligence template. The data of which may subsequently be saved in electronic form on, for example, electronic storage media, such as a hard drive or server.

Information gathered during due diligence may be used to initially screen or identify an investment project or an investor. Information derived from due diligence may be shown to an investor as a tool for screening an investment project and/or as a tool for screening investors.

Due diligence information may also be collected from investors. Due diligence information may include data identifying the particular parties of an investor or investor group. Other private or proprietary information may include the investment history of an investor or investment group, the investment thresholds or target returns for an investment group, the nationality of an investor group or any characteristic which may identify with particularity or generality the characteristics of the investor.

Due diligence may produce a database of information from one or more of the issuers or investors. The thus-gathered due diligence information may be quarantined by the mediator, may be held only by the issuer or investor, and/or may be held by a third party independent of the mediator or any other group involved in the transaction. In an exemplary embodiment, due diligence information is stored in a database that is accessible only by the issuer or the investor.

Exemplary embodiments may include one or more steps or stages in which the investors are reviewed, screened and/or vetted. In one embodiment, a mediator reviews a database of potential investors to identify one or more investors having a high probability of interest in one or more investment projects. The database of potential investors may include proprietary information held only by the mediator or by one or more third parties independent from or controlled by the mediator. The database may include those investors who were previously vetted or have a proven history of access to investment funds and/or who have previously committed investment funds to other investment projects with the mediator. Potential investors may include individual investors, institutional investors, investment banks and the like.

A review of a database of potential investors may be carried out by comparing the characteristics of the investors with the characteristics of one or more particular investment projects or model projects. For example, the mediator may want to place an investment project with a single large investor. Review of a database of potential investors, e.g., by a mediator, may be carried out by matching the total investment desired by the investment project against the investment resources or investment target information known or estimated for the investors in the database of potential investors.

A review may be carried out mathematically. In one exemplary aspect a review is a matching routine which searches particular criteria between investment projects and investors to identify matches. In another embodiment, potential investors are identified by probability. Probability may be determined by comparing a probability score derived from the characteristics of the potential investor relative to the characteristics of the investment project. For example, the investment project may provide estimates of return and/or estimates of risk and/or payback period that vary over wide ranges. The database of potential investors may likewise characterize investors with only limited degrees of precision. For example, a potential investor may be identified as an individual or group desiring to provide funds for investments that have a return on investment within a certain range and/or from developers whose investment projects have a prior history of success. Exact matches may not be determinable for each investment project. Nonetheless investment projects and investors converge with overlapping, touching or exclusive ranges of characteristics.

By scoring any of an investment project and a potential investor according to scales and/or weighting criteria, matches between investment projects and investors can initially be determined. Such matches may later be verified by submitting generalized or generic descriptions of the investment project to the potential investor as a pre-screening to determine a level of interest as discussed above.

Some exemplary embodiments may include informing and/or identifying one or more representatives, compliance officers of an investment project and/or one or more investors that an initial match has been made between investment projects and investors. Compliance officers are those individuals representing an issuer associated with an investment project or an investor who serve the function of reviewing a transaction (e.g., the proposed transaction identified as an initial match) to determine compliance with federal, state or local regulatory requirements. For example, a compliance officer may be an attorney who reviews a transaction. Compliance officers may likewise review a transaction to determine whether conflicts may arise by exchange of proprietary information between parties to the proposed transaction. Compliance officers may have responsibilities throughout the transaction.

A representative may make an inquiry and/or an investor may make a decision to see secret and/or confidential information. After the investor has approved the counterparty's viewing of confidential information, the confidential information is forwarded to the other party for review. At this point the party seeking access to confidential information has gone “over-the-wall”. The date and time the information is made available to the counterparty is recorded and logged, electronically or manually, in a permanent file. Any investor and/or company viewing the confidential information is preferably restricted contractually from trading subsequent to exposure to the confidential information until the transaction is completed or the investment project is abandoned.

Preferably compliance officers for both an issuer and investor provide explicit notices of acceptability for a transaction in stages. During later stages of a transaction one or more compliance officers may provide further permission and/or notices of acceptability to release additional and/or more detailed private or proprietary information to the other party or a mediator acting on behalf of either party.

In certain exemplary embodiments, compliance officer approval may be required prior to any exchange of confidential information. After initial reviews one or more compliance officers may approve the initial stage of the transaction. Approval of initial stages may represent a first instance in which proprietary or private information is exchanged between parties. Exchange of such information may require that those individuals who obtain knowledge or familiarity with private and/or proprietary information from another party (e.g., contaminated individuals) be quarantined from advising in certain other transactions. A contaminated individual or party may be barred from future negotiations or business with the affected party.

Approval upon exchange of a first level of confidential information provides an investor and/or or any party associated with the investment project the ability to determine whether any conflicts or competitive issues affect the feasibility of an agreement between the parties. The system 1000 thus provides one or both of the investor or issuer associated with an investment project an opportunity to undertake a preliminary analysis of a transaction partner before exchanging substantial confidential information and/or a second level or stage of confidential information.

The date and time at which the compliance officers approve exchange of confidential information may be noted, preferably in an electronic database. Likewise, the particular times and dates upon which any individual representing any party in a transaction is exposed to private or proprietary information may be recorded. The particular date and time that an individual or group is exposed to or learns of private and proprietary information serves to characterize the group in later or new negotiations.

In an exemplary embodiment, the system 1000 prepares a log and/or a database of individuals and parties having access to confidential, private or proprietary information. Any individual who is identified as compliant, e.g., approved for exposure to private, confidential and/or proprietary information, by a compliance officer is identified by name or function in a database of information maintained by the mediator or a third party that may be independent from the mediator.

In an exemplary embodiment, the system allows parties and/or the mediator to exchange documents and proprietary information between themselves through the system. The individuals and/or employee functions identified and logged may be given access and knowledge of other parties' private and proprietary information describing financial projects or investors, e.g., compliant individuals are exposed to the private, confidential and/or proprietary information from the other parties to a transaction.

Such private and/or proprietary information is preferably dispensed and distributed only on a “need to know” basis. For example, an accountant working on behalf of an investor may be given information that is particular to the accounts receivable condition of an investment project (preferably these individuals and/or corporations are given all relevant information). The accountant may solely be responsible for determining whether the accounts receivables are in fact collectable. The accountant thus charged with examining accounts receivable may be segregated or quarantined from information unrelated to accounts receivable. For example, such an individual may be quarantined from information describing financial particulars of the investment project. An individual in the function of accountant may likewise be excluded from exposure to information regarding technical details of the investment project.

In certain exemplary embodiments, the system 1000 allows users to prepare draft and/or template documents. Upon review of information describing the investment project and/or investor, one or more individuals or parties involved in a transaction may begin negotiations regarding the details of any transactions between parties. Such preparation may include drafting legal documents, such as contracts, describing the responsibilities of the party and/or the particular financial conditions of the transaction. The ability to draft and amend such documents/templates may be provided with a text editor application that allows parties to draft documents and amendments within a workflow collaboration feature.

Draft documents may be stored in a database of template documents. The template documents may be essentially complete other than particular information describing the investment project and investors of a particular transaction.

As noted above, the system 1000 may allow for the exchanging of draft and/or template documents between parties. Exchange of draft documents may occur directly between parties or may occur through a mediator. In one embodiment, a first group of draft documents is provided to an investor by a mediator. The first group of documents describes the terms, representations, warranties, obligations and conditions of the investment project and/or conditions of a financial transaction associated with the investment project and may, optionally, include private or proprietary information. Preferably the initial exchange of documents is sufficient for the investor to reach a determination regarding whether the particular financial project is appropriate for investment or at least appropriate for further review and the exchange of further private, proprietary or confidential information.

In an exemplary embodiment, investors may review and comment on the draft documents and/or conditions of the investment project through the system 1000. After reviewing documents associated with an investment project, an investor may comment and request changes to the draft documents by amendment or may request changes to the transaction. Preferably the investor makes changes to the draft document based on a template of pre-drafted changes. In one embodiment, the system 1000 may provide an option for the parties to see only the changes to template documents and/or make changes to the changes made.

After an initial exchange of documents, those individuals and/or groups of any of the investment project, mediator and investor who are identified and/or logged as acceptable parties for viewing private, proprietary and/or confidential information from the other party may develop agreed upon documents which define the terms of a transaction. Such terms may include pricing, closing date and any terms which may be a function of the transaction upon execution of definitive documents.

Once agreed upon, documents may be distributed to the parties and deliverables and consideration may thereafter be exchanged.

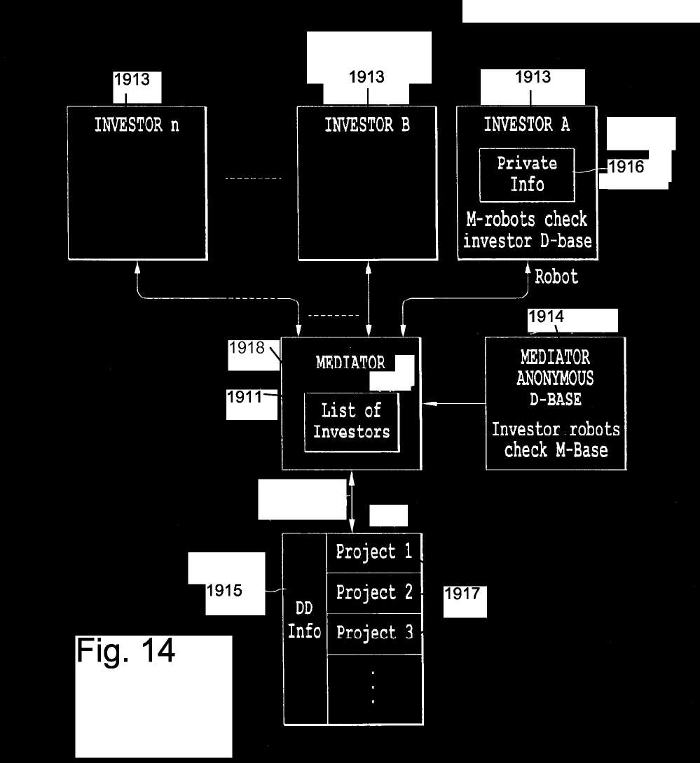

FIG. 14 shows exemplary relationships between parties in a securities placement using an exemplary workflow collaboration feature. As can be seen, a mediator (1911) is a party acting between one or more investment projects (1917) and one or more investors (A-n) (1913). The mediator may maintain in the mediator's possession and/or control a confidential database of investors (1914). The confidential database may identify one or more investors according to particular characteristics of which the probability and/or degree of interest of a particular investor in a particular investment project may be determined or estimated. Alternatively, or in addition, the mediator may be in possession or control of the list of investors (1918) identifying one or more investors or groups of investors who may be interested in participating in certain investment projects. The list of investors may include private and/or proprietary information which is critical to identifying particular investors having goals or targets that are compatible with offered investment projects.

An investment project or group of investment projects (1917) may be segregated from direct communication and inspection by the investor or group of investors (1913) by a virtual wall. The virtual wall exists so that the issuers of the investment projects do not have particular knowledge of the investors. The mediator (1911) may act as a bridge, portal or gateway between issuers of the investment projects and investors. The wall also functions to keep different investors and/or potential investors from knowing one another's identities.

Each investment project may include in a database private or proprietary information associated with the investment project (1915). Likewise the system may maintain a database of private investor information (1916). In this regard possession and control means that the proprietary information of the investment project is physically and electronically under the control of the system 1000.

Investor Relations Feature

An exemplary investor relations feature generally provides means for companies to interact with others with regard to the company's business activities. This may be accomplished in a variety of ways. In one exemplary embodiment, a company is provided with a customizable public interface. That is, an interface that is viewable by other system users and/or the general public. The company may post public information, such as company information, press releases, news or other items of interest to potential investors, such as earnings, SEC filings, prospectuses, etc. The public interface may therefore provide a destination portal for financial information.

In an exemplary embodiment, the system 1000 also allows the company to provide a virtual road show. A road show generally involves representatives of a company seeking investments making appearances at forums where potential investors for a private placement or other type of investment may be marketed. In this respect, the system 1000 may allow the company to produce, upload, and publish video, audio, and documentation relating to an investment event, such as a primary offering, a private placement, etc. In at least one embodiment, the virtual road show is tied to an investment event through another feature of the platform. For example, the company or issuer may upload videos in connection with a placement conducted through the workflow collaboration feature. The virtual road show may include content, such as video, that is maintained in confidence or otherwise not released to the investor until an investor agrees to maintain the information associated with an investment project confidential. Content uploaded to the system 1000 may be associated with an investment project and/or a transaction. Once such content is uploaded, the system 1000 may send notices to parties in a transaction associated with an investment project indicating that new virtual road show content is available. The company may also upload videos that are deemed public. Thus, a database of content may be maintained with an indication therein that represents whether or not a particular content item is public or private. In certain instances, for example, when a placement is complete, some of the private content may be migrated automatically or otherwise into the public content.

While the foregoing has been described in some detail for purposes of clarity and understanding, it will be appreciated by one skilled in the art, from a reading of the disclosure, that various changes in form and detail can be made without departing from the true scope of the application.

What is claimed is:

1. A method comprising:
causing at least one interface screen to be displayed on at least one client device, the at least one interface screen comprising at least one item of information regarding an offering of primary securities and at least one form element for an issuer of the primary securities to define terms of an offer to sell the primary securities;
receiving from the at least one client device the offer to sell the primary securities and a confirmation that the issuer of the primary securities is legally authorized to issue the primary securities; and
communicating the offer to sell the primary securities to a trading market.

2. The method of claim 1, wherein the trading market comprises at least one of an exchange and an over the counter marketplace.

3. The method of claim 1, wherein the primary securities comprise new equity securities indistinguishable from corresponding secondary securities in the trading market.

4. The method of claim 1, wherein the primary securities comprise new debt securities indistinguishable from corresponding secondary securities in the trading market.

5. The method of claim 1, comprising communicating the offer to a trading desk associated with an intermediary and communicating the offer to the trading market via the intermediary.

6. The method of claim 1, wherein the legal authority to issue the primary security requires a regulatory registration, and wherein the at least one interface screen comprises at least one form element for the primary issuer to confirm that the issuer has filed the regulatory registration for the offering and that the regulatory registration is still in force.

7. The method of claim 6, wherein the regulatory registration comprises a shelf registration.

8. The method of claim 1, wherein the at least one interface screen further comprises a display of market data associated with the primary securities in the trading market.

9. The method of claim 8, wherein the at least one item of information regarding the offering comprises a size of the offering or a number of primary securities that the primary issuer is authorized legally to sell, and wherein the at least one interface screen comprises a display of the cash value of the offering.

10. The method of claim 1, wherein the at least one item of information regarding the offering comprises a remaining cash value of the offering taking into account a size of the offering or a number of primary securities that the primary issuer is authorized legally to sell, and any securities previously sold in the offering.

11. The method of claim 10, comprising calculating a number of primary securities available for sale in the offering based on the remaining cash value of the offering and a market price of the primary securities in the trading market.

12. The method of claim 1, wherein the at least one interface screen comprises at least one form element for the primary issuer to specify instructions for selling the primary securities on the trading market, the method comprising communicating the offer to sell the primary securities with the instructions specified by the issuer.

13. The method of claim 12, wherein the instructions comprise an indication that the offer is at least one of a passive, a midpoint, an aggressive, a volume weighted average price (VWAP), a participate, a day offer, and a good till cancelled offer.

14. The method of claim 12, wherein the instructions comprise an indication that the offer to sell the primary securities is a market order, and wherein the offer communicated to the trading market is a market order.

15. The method of claim 1, wherein the primary securities are offered without underwriting.

16. The method of claim 1, wherein the primary securities are offered using at least one of an underwriter and a placement agent.

17. The method of claim 1, comprising receiving a deposit of a number of unissued, authorized securities for the offering from the issuer, wherein the at least one item of information regarding the offering comprises the number of unissued, authorized securities deposited.

18. The method of claim 17, comprising determining a remaining number of securities available to be sold in the offering based on the number of securities deposited and any securities sold in the offering, wherein the at least one interface screen comprises a display of the remaining number of securities available to be sold in the offering.

19. A method comprising:
receiving and storing details of an issuer and a shelf registration of said issuer, said shelf registration authorizing said issuer to sell primary securities up to a specified dollar amount;
receiving, pursuant to a distribution agreement, a first number of unissued, authorized shares of said primary securities whose total value does not exceed said specified dollar amount;
receiving, via a user interface, an order from said issuer to sell a second number of shares of said primary securities, said second number not exceeding said first number; and
transmitting said order to a securities marketplace.

20. A method as in claim 19, further comprising receiving an indication that at least a portion of said order has been executed.

21. A method as in claim 20, further comprising transmitting data comprising said indication to said user interface for display to said issuer.

22. A method as in claim 21, wherein said user interface displays to said issuer a total dollar amount of shares of said primary securities sold.

23. A method comprising:
displaying at least one interface screen on a client device, the at least one interface screen comprising at least one item of information regarding an offering of primary securities and at least one form element for an issuer of the primary securities to define terms of an offer to sell the primary securities in a trading market;
communicating the offer to sell the primary securities from the client device to a computing device coupled to the client device over a network; and
confirming that the issuer of the primary securities is legally authorized to issue the primary securities.

24. The method of claim 23, wherein the trading market comprises at least one of an exchange and an over the counter marketplace.

25. The method of claim 23, wherein the primary securities comprise new equity securities indistinguishable from corresponding secondary securities in the trading market.

26. The method of claim 23, wherein the legal authority to issue the primary security requires a regulatory registration, and wherein the at least one interface screen comprises at least one form element for the primary issuer to confirm that the issuer has filed the regulatory registration for the offering and that the regulatory registration is still in force.

27. The method of claim 26, wherein the regulatory registration comprises a shelf registration.

28. The method of claim 23, wherein the at least one interface screen further comprises a display of market data associated with the primary securities in the trading market.

29. The method of claim 28, wherein the at least one item of information regarding the offering comprises a size of the offering or a number of authorized primary securities that the primary issuer is authorized legally to sell, and wherein the at least one interface screen comprises a display of the cash value of the offering.

30. The method of claim 23, wherein the at least one item of information regarding the offering comprises a remaining cash value of the offering taking into account a size of the offering or a number of authorized primary securities that the primary issuer is authorized legally to sell, and any securities previously sold in the offering.

31. The method of claim 30, the interface screen comprising a display of a number of primary securities available for sale in the offering calculated based on the remaining cash value of the offering and a market price of the primary securities in the trading market.

32. The method of claim 23, comprising depositing a number of unissued, authorized securities for the offering with a provider, wherein the at least one item of information regarding the offering comprises the number of unissued, authorized securities deposited.

33. The method of claim 32, wherein the at least one interface screen comprises a display of a remaining number of securities available to be sold in the offering, the remaining number of securities available to be sold in the offering determined based on the number of securities deposited and any securities previously sold in the offering.

34. A system comprising at least one computing device coupled to at least one client device over a network, the at least one computing device operable at least to:
cause at least one interface screen to be displayed on the at least one client device, the at least one interface screen comprising at least one item of information regarding an offering of primary securities and at least one form element for an issuer of the primary securities to define terms of an offer to sell the primary securities;
receive from the at least one client device the offer to sell the primary securities and a confirmation that the issuer of the primary securities is legally authorized to issue the primary securities; and
communicate the offer to sell the primary securities to a trading market.

35. The system of claim 34, wherein the trading market comprises at least one of an exchange and an over the counter marketplace.

36. The system of claim 34, wherein the primary securities comprise new equity securities indistinguishable from corresponding secondary securities in the trading market.

37. The system of claim 34, wherein the primary securities comprise new debt securities indistinguishable from corresponding secondary securities in the trading market.

38. The system of claim 34, the at least one computing device further operable to communicate the offer to a trading desk associated with an intermediary and communicate the offer to the trading market via the intermediary.

39. The system of claim 34, wherein the legal authority to issue the primary security requires a regulatory registration, and wherein the at least one interface screen comprises at least one form element for the primary issuer to confirm that the issuer has filed the regulatory registration for the offering and that the regulatory registration is still in force.

40. The system of claim 39, wherein the regulatory registration comprises a shelf registration.

41. The system of claim 34, wherein the at least one interface screen further comprises a display of market data associated with the primary securities in the trading market.

42. The system of claim 41, wherein the at least one item of information regarding the offering comprises a size of the offering or a number of authorized primary securities that the primary issuer is authorized legally to sell, and wherein the at least one interface screen comprises a display of the cash value of the offering.

43. The system of claim 34, wherein the at least one item of information regarding the offering comprises a remaining cash value of the offering taking into account a size of the offering or a number of authorized primary securities that the primary issuer is authorized legally to sell, and any securities previously sold in the offering.

44. The system of claim 43, the at least one computing device further operable to calculate a number of primary securities available for sale in the offering based on the remaining cash value of the offering and a market price of the primary securities in the trading market.

45. The system of claim 34, wherein the at least one interface screen comprises at least one form element for the primary issuer to specify instructions for selling the primary securities on the trading market, the at least one computing device further operable to communicate the offer to sell the primary securities with the instructions specified by the issuer.

46. The system of claim 45, wherein the instructions comprise an indication that the offer is at least one of a passive, a midpoint, an aggressive, a volume weighted average price (VWAP), a participate, a day offer, and a good till cancelled offer.

47. The system of claim 45, wherein the instructions comprise an indication that the offer to sell the primary securities is a market order, and wherein the offer communicated to the trading market is a market order.

48. The system of claim 43, wherein the primary securities are offered without underwriting.

49. The system of claim 34, wherein the primary securities are offered using at least one of an underwriter and a placement agent.

50. The system of claim 34, the at least one computing device further operable to receive a number of unissued, authorized securities for the offering from the issuer deposited, wherein the at least one item of information regarding the offering comprises the number of unissued, authorized securities deposited.

51. The system of claim 50, the at least one computing device further operable to determine a remaining number of securities available to be sold in the offering based on the number of securities deposited and any securities sold in the offering, wherein the at least one interface screen comprises a display of the remaining number of securities available to be sold in the offering.

52. A system comprising at least one computing device coupled to at least one client device over a network, the at least one computing device operable at least to:
receive and store details of an issuer and a shelf registration of said issuer, said shelf registration authorizing said issuer to sell primary securities up to a specified dollar amount;
receive, pursuant to a distribution agreement, a first number of unissued, authorized shares of said primary securities whose total value does not exceed said specified dollar amount;
receive, via a user interface, an order from said issuer to sell a second number of shares of said primary securities, said second number not exceeding said first number; and
transmit said order to a securities marketplace.

53. A system as in claim 52, the at least one computing device further operable to receive an indication that at least a portion of said order has been executed.

54. A system as in claim 53, the at least one computing device further operable to transmit data comprising said indication to said user interface for display to said issuer.

55. A system as in claim 54, wherein said user interface displays to said issuer a total dollar amount of shares of said primary securities sold.

56. A system comprising at least one client device coupled over a network to at least one computing device, the at least one client device operable at least to:
display at least one interface screen comprising at least one item of information regarding an offering of primary securities and at least one form element for an issuer of the primary securities to define terms of an offer to sell the primary securities in a trading market;
communicate the offer to sell the primary securities to the computing device coupled to the client device over a network; and
confirm that the issuer of the primary securities is legally authorized to issue the primary securities.

57. The system of claim 56, wherein the trading market comprises at least one of an exchange and an over the counter marketplace.

58. The system of claim 56, wherein the primary securities comprise new equity securities indistinguishable from corresponding secondary securities in the trading market.

59. The system of claim 56, wherein the legal authority to issue the primary security requires a regulatory registration, and wherein the at least one interface screen comprises at least one form element for the primary issuer to confirm that the issuer has filed the regulatory registration for the offering and that the regulatory registration is still in force.

60. The system of claim 59, wherein the regulatory registration comprises a shelf registration.

61. The system of claim 56, wherein the at least one interface screen further comprises a display of market data associated with the primary securities in the trading market.

62. The system of claim 61, wherein the at least one item of information regarding the offering comprises a size of the offering or a number of authorized primary securities that the primary issuer is authorized legally to sell, and wherein the at least one interface screen comprises a display of the cash value of the offering.

63. The system of claim 56, wherein the at least one item of information regarding the offering comprises a remaining cash value of the offering taking into account a size of the offering or a number of authorized primary securities that the primary issuer is authorized legally to sell, and any securities previously sold in the offering.

64. The system of claim 63, the interface screen comprising a display of a number of primary securities available for sale in the offering calculated based on the remaining cash value of the offering and a market price of the primary securities in the trading market.

65. The system of claim 56, wherein the primary issuer deposits a number of unissued, authorized securities for the offering with a provider, and wherein the at least one item of information regarding the offering comprises the number of unissued, authorized securities deposited.

66. The system of claim 65, wherein the at least one interface screen comprises a display of a remaining number of securities available to be sold in the offering, the remaining number of securities available to be sold in the offering determined based on the number of securities deposited and any securities previously sold in the offering.

67. A non-transitory computer readable medium having software stored thereon that when executed by a computing device causes the computing device to perform a method comprising:
causing at least one interface screen to be displayed on at least one client device, the at least one interface screen comprising at least one item of information regarding an offering of primary securities and at least one form element for an issuer of the primary securities to define terms of an offer to sell the primary securities;
receiving from the at least one client device the offer to sell the primary securities and a confirmation that the issuer of the primary securities is legally authorized to issue the primary securities; and
communicating the offer to sell the primary securities to a trading market.

68. A non-transitory computer readable medium having software stored thereon that when executed by a computing device causes the computing device to perform a method comprising:
receiving and storing details of an issuer and a shelf registration of said issuer, said shelf registration authorizing said issuer to sell primary securities up to a specified dollar amount;
receiving, pursuant to a distribution agreement, a first number of unissued, authorized shares of said primary securities whose total value does not exceed said specified dollar amount;
receiving, via a user interface, an order from said issuer to sell a second number of shares of said primary securities, said second number not exceeding said first number; and
transmitting said order to a securities marketplace.

69. A non-transitory computer readable medium having software stored thereon that when executed by a client device causes the computing device to perform a method comprising:
displaying at least one interface screen on the client device, the at least one interface screen comprising at least one item of information regarding an offering of primary securities and at least one form element for an issuer of the primary securities to define terms of an offer to sell the primary securities in a trading market;
communicating the offer to sell the primary securities from the client device to a computing device coupled to the client device over a network; and
confirming that the issuer of the primary securities is legally authorized to issue the primary securities.

70. A method comprising:
receiving and storing details of an issuer and a shelf registration of said issuer, said shelf registration authorizing said issuer to sell primary securities up to a specified number of securities;
receiving, pursuant to a distribution agreement, a first number of unissued, authorized shares of said primary securities that does not exceed said specified number of securities;
receiving, via a user interface, an order from said issuer to sell a second number of shares of said primary securities, said second number not exceeding said first number; and
transmitting said order to a securities marketplace.

71. A system comprising at least one computing device coupled to at least one client device over a network, the at least one computing device operable at least to:
receive and storing details of an issuer and a shelf registration of said issuer, said shelf registration authorizing said issuer to sell primary securities up to a specified number of securities;
receive, pursuant to a distribution agreement, a first number of unissued, authorized shares of said primary securities that does not exceed said specified number of securities;
receive, via a user interface, an order from said issuer to sell a second number of shares of said primary securities, said second number not exceeding said first number; and
transmit said order to a securities marketplace.

72. A non-transitory computer readable medium having software stored thereon that when executed by a computing device causes the computing device to perform a method comprising:
receiving and storing details of an issuer and a shelf registration of said issuer, said shelf registration authorizing said issuer to sell primary securities up to a specified number of securities;
receiving, pursuant to a distribution agreement, a first number of unissued, authorized shares of said primary securities that does not exceed said specified number of securities;
receiving, via a user interface, an order from said issuer to sell a second number of shares of said primary securities, said second number not exceeding said first number; and
transmitting said order to a securities marketplace.
